(19) United States
(12) Patent Application Publication
(10) Pub. No.: US 2024/0392208 A1
(43) Pub. Date: Nov. 28, 2024

(54) CYCLOPROPANATED FRAGRANCE COMPOUNDS

(71) Applicant: SYMRISE AG, Holzminden (DE)

(72) Inventors: Stefan BRÄSE, Troisdorf (DE); Patrick GRUHS, Karlsruhe (DE); Vijayanand CHANDRASEKARAN, Holzminden (DE); Bernd HÖLSCHER, Halle (DE)

(73) Assignee: SYMRISE AG, Holzminden (DE)

(21) Appl. No.: 18/689,145

(22) PCT Filed: Sep. 13, 2021
(86) PCT No.: PCT/EP2021/075035

§ 371 Date: Mar. 5, 2024

(51) Int. Cl. C11B 9/00

(52) U.S. Cl. CPC C11B 9/0003; C11B 9/0034; C11B 9/0049

(57) ABSTRACT

The present invention relates to the use of certain cyclopropanated compounds as a fragrance. In particular, the compounds provide fruity and/or floral olfactory notes. Furthermore, the invention provides fragrance compositions and perfumed products comprising the cyclopropanated compounds as well as a method for producing a perfumed product. The invention also relates to a method of producing the cyclopropanated compounds and provides a number of novel cyclopropanated compounds.

### FIELD OF THE DISCLOSURE

The present invention relates to the use of certain cyclopropanated compounds as a fragrance. In particular, the compounds provide fruity and/or floral olfactory notes. Furthermore, the invention provides fragrance compositions and perfumed products comprising the cyclopropanated compounds as well as a method for producing a perfumed product. The invention also relates to a method of producing the cyclopropanated compounds and provides a number of novel cyclopropanated compounds.

### BACKGROUND

Despite a large number of available fragrance substances, there is a constant need for novel compounds and combinations of compounds in the perfume and fragrance industry. In order to satisfy customers' needs, new fragrance profiles and complex olfactory impressions have to be developed on a regular basis. The industry is therefore constantly searching for new compounds, which exhibit special sensory properties and can serve as a basis for the composition of novel perfumes and fragrances.

The cyclopropane ring is a motif found in several fragrance compounds and methods are described in the literature to obtain cyclopropanated fragrance compounds (EP1262474A1, Schröder, Chemistry & Biodiversity, Vol. 11 (2014), 1734-1751). Cyclopropanation of alkenes often provides interesting new olfactory properties and an increased stability of the resulting fragrance molecules. Furthermore, a fragrance may be intensified by the cyclopropanation. Therefore, there is a constant drive to discover new cyclopropanated compounds and assess their potential in the fragrance industry. It is particularly desirable to introduce more variation into cyclopropanated compounds.

Cyclopropanation strategies have been summarized in a general context by Ebner and Carreira (Chemical Reviews, 2017, 117, 11651-11679) and Wu et al. (Organic and Biomolecular Chemistry, 2018, 16, 7315-7329). Rhodium-catalyzed cyclopropanation with diazoesters has been described by Panne et al. in Organic Letters, 2008, 10 (14), 2987-2989. However, this reaction has not been applied for larger and complex molecules, which might provide interesting new fragrances.

### DESCRIPTION

It was an objective of the present invention to provide cyclopropanated compounds with new interesting olfactory properties. The compounds should provide an attractive and stable fragrance.

Furthermore, it was an objective of the present invention to provide a method, which allows to obtain a wide variety of substituted cyclopropanated compounds, which provide new and interesting fragrances.

The above objective is met by the use of a compound or mixture of two or more compounds of formula (I)

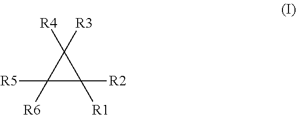

wherein R1=COOX with X=methyl, ethyl or tert-butyl, or
R1=CH2OH,
R2=H or methyl, and
R3 to R6 are defined as shown in compounds (1) to (34) below,
wherein the compound(s) is/are selected from the group consisting of.

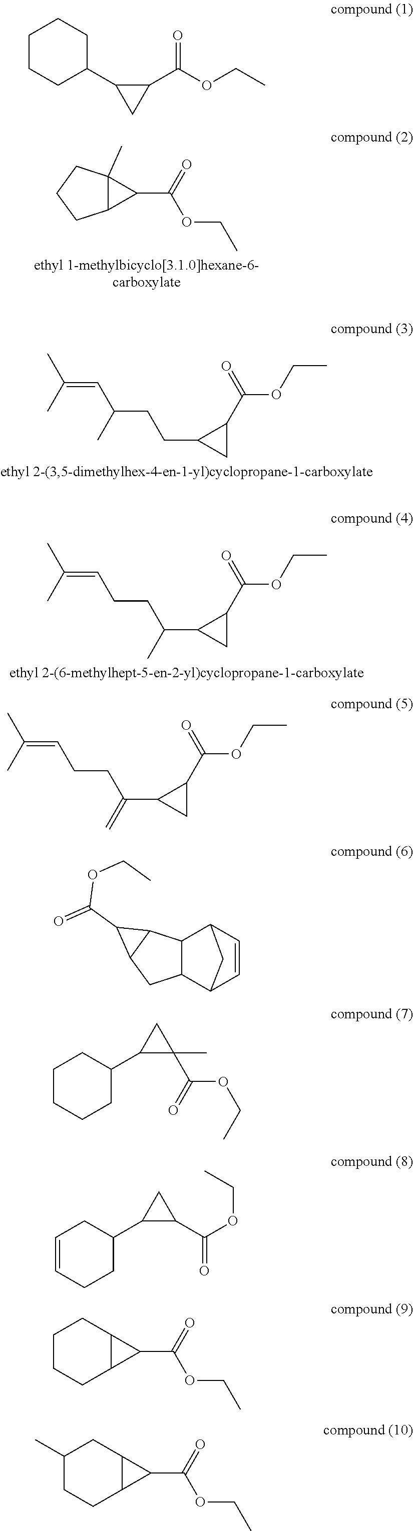

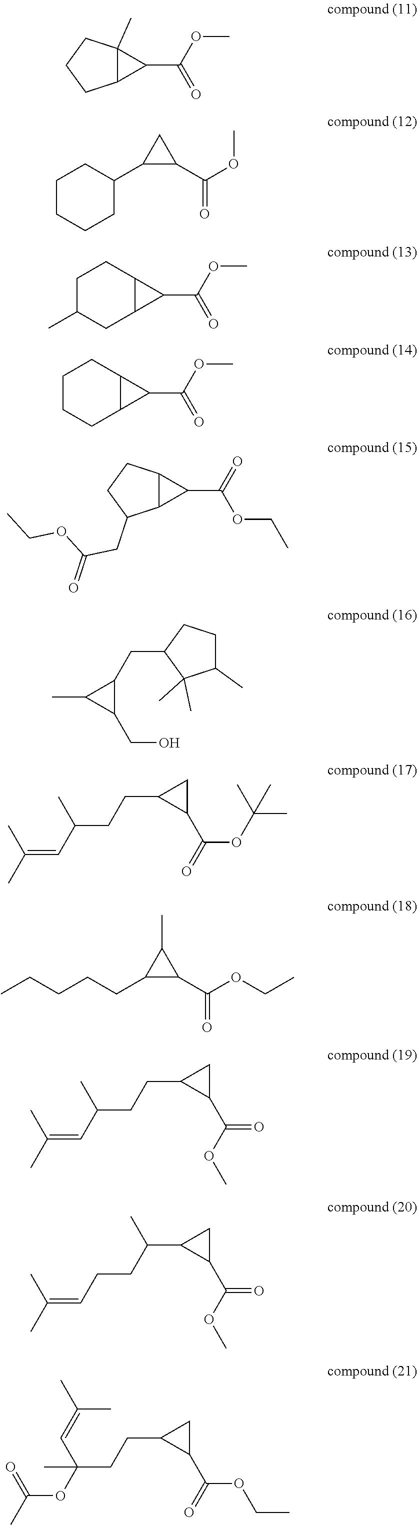

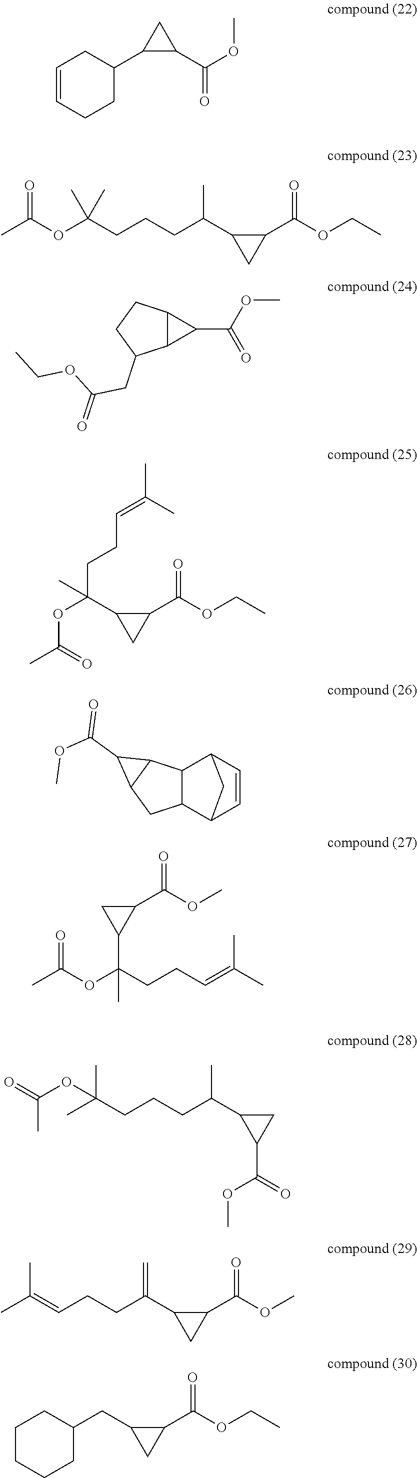

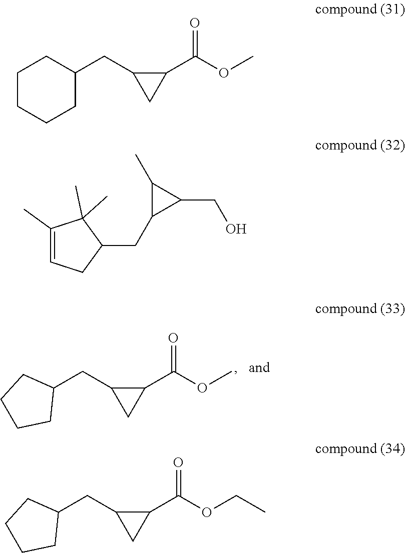

as a fragrance.

In the context of the present invention, it was discovered that the compounds (1) to (34) provide attractive and unique olfactory characteristics, which make them useful as a fragrance.

The search for suitable substances that led to the present invention was complicated by the following facts:
The mechanisms of olfactory perception are not sufficiently known;
the connections between the specific olfactory perception on the one hand and the chemical structure of the associated fragrance substance on the other hand have not been sufficiently researched;
often even minor changes in the structural set-up of a known fragrance substance cause major changes in the sensory properties and affect the tolerance for the human organism.

According to a preferred embodiment of the use described above, the compound or mixture of two or more compounds of formula (I) is/are enantiomerically pure, racemic or a mixture of diastereoisomers.

The compounds (1) to (34) have been found to provide in particular fruity and floral olfactory notes. In a preferred embodiment of the use described above, the compound or mixture of two or more compounds of formula (I) has a fruity and/or floral fragrance.

Table 1 provides an overview of the olfactory properties that have been identified for compounds (1) to (34) by evaluation of a panel of trained fragrance experts.

TABLE 1
Olfactory properties of compounds (1) to (34)

| No. | Structure/Name | Odor |
|---|---|---|
| (1) | 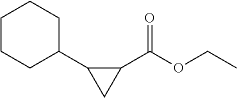 | Fruity, floral, pineapple, ester, buttery |
| | ethyl 2-cyclohexylcyclopropane-1-carboxylate | |
| (2) | 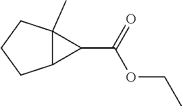 | Fruity, tropical, raspberry, apple, floral |
| | ethyl 1-methylbicyclo[3.1.0]hexane-6- | |
| | carboxylate | |
| (3) | 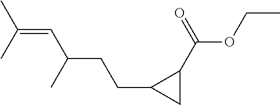 [SMILES: CCOC(=O)C1CC1CCC(C)C=C(C)C] | Strong Grape- fruit, pineapple, Rhubarb, nature. |
| | ethyl 2-(3,5-dimethylhex-4-en-1-yl)cyclopropane-1-car- | |
| | boxylate | |
| (4) | 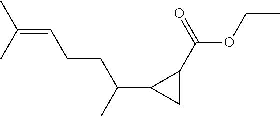 [SMILES: CCOC(=O)C1CC1C(C)CCC=C(C)C] | Very strong, fruity, more Rhubarb |
| | ethyl 2-(6-methylhept-5-en-2-yl)cyclopropane-1-carboxylate | |
| (5) | 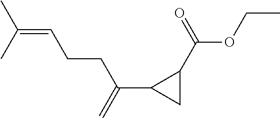 [SMILES: C=C(CCC=C(C)C)C1CC1C(=O)OCC] | Fruity, green, boiled Rhubarb |
| | ethyl 2-(6-methylhepta-1,5-dien-2-yl)cyclopropane-1-carboxylate | |
| (6) | 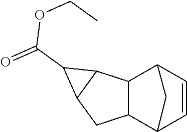 [SMILES: CCOC(=O)C1C2CC3C4C=CC(C4)C3C21] | Earthy |
| | ethyl 1,1a,1b,2,5,5a,6,6a-octahydro-2,5- | |
| | methaneocyclopropa[a]indene-1-carboxylate | |
| (7) | 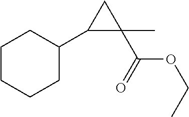 | Fruity, green, apricot |
| | ethyl 2-cyclohexyl-1-methylcyclopropane-1-carboxylate | |
| (8) | 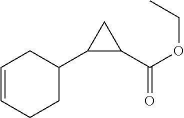 | Fruity, strong strawberry, pineapple |
| | ethyl 2-(cyclohex-3-en-1-yl)cyclopropane-1-carboxylate | |
| (9) | 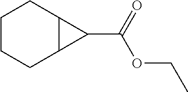 | currant, fruity, banana, buttery |
| | ethyl bicyclo[4.1.0]heptane-7-carboxylate | |
| (10) | 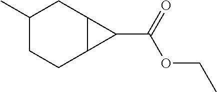 | Green, fruity, banana, kiwi-very strong |
| | ethyl 3-methylbicyclo[4.1.0]heptane-7-carboxylate | |
| (11) | 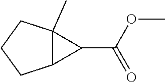 | currant, fruity, banana, Eisbonbon |
| | methyl 1-methylbicyclo[3.1.0]hexane-6-carboxylate | |
| (12) | 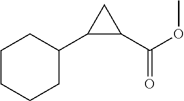 | Fruity, Flowery, green, leeks |
| | methyl 2-cyclohexylcyclopropane-1-carboxylate | |
| (13) | 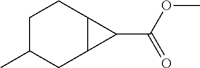 | Fruity, leeks, Eisbonbon |
| | methyl 3-methylbicyclo[4.1.0]heptane-7-carboxylate | |
| (14) | 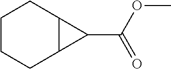 | Fruity, leeks, Eisbonbon |
| | methyl bicyclo[4.1.0]heptane-7-carboxylate | |
| (15) | 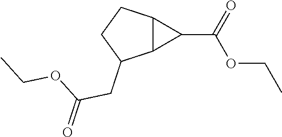 [SMILES: CCOC(=O)CC1CCC2C(C(=O)OCC)C12] | Melone |
| | ethyl 2-(2-ethoxy-2-oxoethyl)bicyclo[3.1.0]hexane- | |
| | 6-carboxylate | |
| (16) | 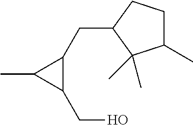 | Green, weak |
| | (2-methyl-3-((2,2,3-trimethylcyclopentyl)methyl)cyclo- | |
| | propyl)methanol | |
| (17) | 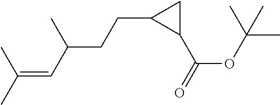 [SMILES: CC(C)=CC(C)CCC1CC1C(=O)OC(C)(C)C] | Fruity, fresh, flowery, rose- wood |
| | tert-butyl 2-(3,5-dimethylhex-4-en-1-yl)cyclopropane-1- | |
| | carboxylate | |
| (18) | 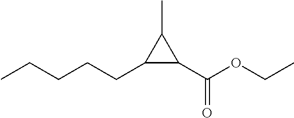 | Weak Fruity |
| | ethyl 2-methyl-3-pentylcyclopropane-1-carboxylate | |
| (19) | 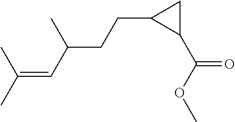 | Rhubarb very strong, nature, |
| | methyl 2-(3,5-dimethylhex-4-en-1-yl)cyclopropane- | |
| | 1-carboxylate | |
| (20) | 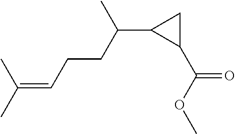 | Rhubarb very strong, nature, |
| | methyl 2-(6-methylhept-5-en-2-yl)cyclopropane-1-carboxylate | |
| (21) | 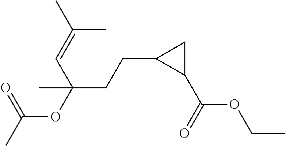 [SMILES: CCOC(=O)C1CC1CCC(C)(C=C(C)C)OC(C)=O] | Fruity |
| | ethyl 2-(3-acetoxy-3,5-dimethylhex-4-en-1-yl)cyclopro- | |
| | pane-1-carboxylate | |
| (22) | 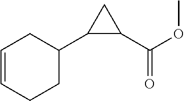 | Fruity, buttery |
| | methyl 2-(cyclohex-3-en-1-yl)cyclopropane-1-carboxylate | |
| (23) | 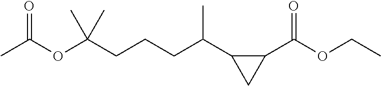 [SMILES: CCOC(=O)C1CC1C(C)CCCC(C)(C)OC(C)=O] | Fresh |
| | ethyl 2-(6-acetoxy-6-methylheptan-2-yl)cyclopropane- | |
| | 1-carboxylate | |
| (24) | 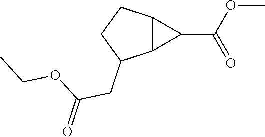 [SMILES: CCOC(=O)CC1CCC2C(C(=O)OC)C12] | Fresh, fruity, very weak |
| | methyl 2-(2-ethoxy-2-oxoethyl)bicyclo[3.1.0]hexane- | |
| | 6-carboxylate | |
| (25) | 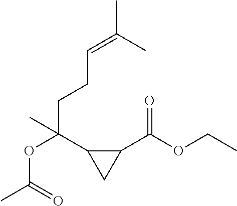 [SMILES: CCOC(=O)C1CC1C(C)(CCC=C(C)C)OC(C)=O] | Fruity |
| | ethyl 2-(2-acetoxy-6-methylhept-5-en-2-yl)cyclopro- | |
| | pane-1-carboxylate | |
| (26) | 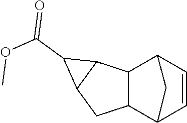 | Fruity |
| | methyl 1,1a,1b,2,5,5a,6,6a-octahydro-2,5- | |
| | methanocyclopropa[a]indene-1-carboxylate | |
| (27) | 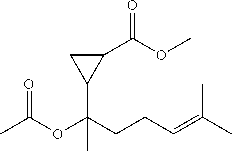 [SMILES: COC(=O)C1CC1C(C)(CCC=C(C)C)OC(C)=O] | Fresh |
| | methyl 2-(2-acetoxy-6-methylhept-5-en-2-yl)cyclopro- | |
| | pane-1-carboxylate | |
| (28) | 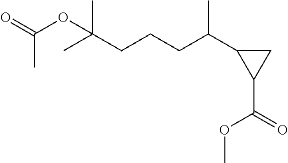 [SMILES: COC(=O)C1CC1C(C)CCCC(C)(C)OC(C)=O] | Fruity |
| | methyl 2-(6-acetoxy-6-methylheptan-2-yl)cyclopropane- | |
| | 1-carboxylate | |
| (29) | 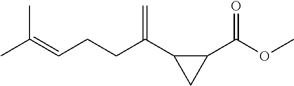 | Nature, garden herbs, aroma, |
| | methyl 2-(6-methylhepta-1,5-dien-2-yl)cyclopropane-1- | |
| | carboxylate | |
| (30) | 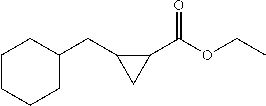 | Fruity |
| | ethyl 2-(cyclohexylmethyl)cyclopropane-1-carboxylate | |
| (31) | 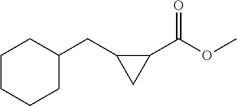 | Fruity, pineapple |
| | methyl 2-(cyclohexylmethyl)cyclopropane-1-carboxylate | |
| (32) | 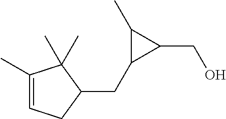 | Creamy, woody, weak, fruity |
| | (2-methyl-3-((2,2,3-trimethylcyclopent-3-en-1- | |
| | yl)methyl)cyclopropyl)methanol | |
| (33) | 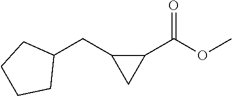 | Fruity, pineapple |
| | methyl 2-(cyclopentylmethyl)cyclopropane-1- | |
| | carboxylate | |
| (34) | 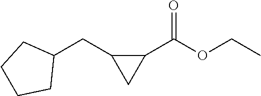 | Pear, fruity |
| | ethyl 2-(cyclopentylmethyl)cyclopropane-1-carboxylate | |

In a preferred embodiment of the use described above, the compound (1) provides one or more olfactory notes selected from the group consisting of fruity, floral, pineapple, ester and buttery and/or the compound (2) provides one or more olfactory notes selected from the group consisting of fruity, tropical, raspberry, apple and floral and/or the compound (3) provides one or more olfactory notes selected from the group consisting of grapefruit, pineapple, rhubarb and nature and/or the compound (4) provides one or more olfactory notes selected from the group consisting of fruity and rhubarb and/or the compound (5) provides one or more olfactory notes selected from the group consisting of fruity, green and boiled rhubarb and/or the compound (6) provides an earthy olfactory note and/or the compound (7) provides one or more olfactory notes selected from the group consisting of fruity, green and apricot and/or the compound (8) provides one or more olfactory notes selected from the group consisting of fruity, strawberry and pineapple and/or the compound (9) provides one or more olfactory notes selected from the group consisting of currant, fruity, banana and buttery and/or the compound (10) provides one or more olfactory notes selected from the group consisting of green, fruity, banana and kiwi and/or the compound (11) provides one or more olfactory notes selected from the group consisting of currant, fruity, banana and “Eisbonbon” (i.e. candy, sweet, fresh) and/or the compound (12) provides one or more olfactory notes selected from the group consisting of fruity, flowery, green and leeks and/or the compound (13) provides one or more olfactory notes selected from the group consisting of fruity, leeks and “Eisbonbon” (i.e. candy, sweet, fresh) and/or the compound (14) provides one or more olfactory notes selected from the group consisting of fruity, leeks and “Eisbonbon” (i.e. candy, sweet, fresh) and/or the compound (15) provides a melon olfactory note and/or the compound (16) provides a green olfactory note and/or the compound (17) provides one or more olfactory notes selected from the group consisting of fruity, fresh, flowery and rosewood and/or the compound (18) provides a fruity olfactory note and/or the compound (19) provides one or more olfactory notes selected from the group consisting of rhubarb and nature and/or the compound (20) provides one or more olfactory notes selected from the group consisting of rhubarb and nature and/or the compound (21) provides a fruity olfactory note and/or the compound (22) provides one or more olfactory notes selected from the group consisting of fruity and buttery and/or the compound (23) provides a fresh olfactory note and/or the compound (24) provides one or more olfactory notes selected from the group consisting of fresh and fruity and/or the compound (25) provides a fruity olfactory note and/or the compound (26) provides a fruity olfactory note and/or the compound (27) provides a fresh olfactory note and/or the compound (28) provides a fruity olfactory note and/or the compound (29) provides one or more olfactory notes selected from the group consisting of nature, garden herbs and aroma and/or the compound (30) provides a fruity olfactory note and/or the compound (31) provides one or more olfactory notes selected from the group consisting of fruity and pineapple and/or the com-pound (32) provides one or more olfactory notes selected from the group consisting of creamy, woody and fruity and/or the compound (33) provides one or more olfactory notes selected from the group consisting of fruity and pineapple and/or the compound (34) provides one or more olfactory notes selected from the group consisting of pear and fruity.

The present invention also relates to a fragrance composition comprising one or a mixture of two or more compounds of formula (I) as defined above.

The compounds of formula (I) as defined above may be used together with other fragrance substances. Such fragrance compositions may be prepared in the usual way, for example by simple mixing or homogenisation of the ingredients. These further fragrance substances can be any other fragrance substances. Examples of fragrances that can be advantageously combined with the compounds of formula (I) as defined above within the scope of the present invention can be found, for example, in S. Arctander, Perfume and Flavor Materials, Vol. I and II, Montclair, N. J. 1969, Eigenverlag, or K. Bauer et al., Common Fragrance and Flavor Materials, 4th Edition, Wiley-VCH, Weinheim 2001.

The fragrance compositions according to the invention may be adsorbed to a carrier, which ensures both a fine distribution of the fragrance substances in a product and a controlled release during application. Such carriers may be porous inorganic materials such as light sulphate, silica gels, zeolites, gypsums, clays, clay granules, gas concrete, etc. or organic materials such as wood, cellulose-based materials, sugars, dextrins (e.g. maltodextrin) or plastics such as PVC, polyvinyl acetates or polyurethanes. The composition according to the invention and a carrier may represent a perfumed product according to the invention (as described below).

Fragrance compositions or products according to the invention may also be present in microencapsulated form, spray-dried form, as inclusion complexes or as extrusion products and—in case of a fragrance composition—may be added in this form to a product to be perfumed (as described herein below).

If applicable, the properties of such modified compositions or products can be further optimised by so-called “coating” with suitable materials in view of a more targeted release of fragrance, preferably using wax-like plastics such as e.g. polyvinyl alcohol. The resulting products in turn are products according to the invention.

Microencapsulation can, for example, be achieved by the so-called coacervation process with the aid of capsule materials, e.g. polyurethane-like substances or soft gelatine. Spray-dried products are preferably produced by spray-drying an emulsion or dispersion containing the fragrance composition, whereby modified starches, proteins, dextrins and vegetable gums can be used as carriers. Inclusion complexes can be prepared e.g. by incorporating dispersions of the fragrance composition and cyclodextrins or urea derivatives into a suitable solvent, e.g. water. Extrusion products can be obtained e.g. by fusing the fragrance compositions with a suitable wax-like substance and by extrusion followed by solidification, if applicable in a suitable solvent, e.g. isopropanol.

Furthermore, the present invention also relates to a (perfumed) product comprising one or a mixture of two or more compounds of formula (I) as defined above or a fragrance composition as defined above.

In a preferred embodiment, the product is selected from the group consisting of detergents and cleaning agents, hygiene or care products, preferably in the field of body and hair care, cosmetics and household.

According to a preferred embodiment, the product is selected from the group consisting of perfume extracts, eau de parfums, eau de toilettes, after-shave, eau de colognes, preshave-products, splash colognes, perfumed wet wipes, acidic, alkalic and neutral cleaning agents, textile refreshener, iron aids, liquid laundry soaps, laundry soap powders, laundry pre-treatment agents, fabric softerners, cleaning soaps, cleaning tabs, disinfectants, surface disinfectants, air improver, aerosol sprays, waxes and polishes, body care products, hand crèmes and lotions, foot crèmes and lotions, hair removal crèmes and lotions, aftershave crèmes and lotions, tanning crèmes and lotions, hair care products, deodorants and antiperspirants, products of decorative cosmetics, candles, lamp oils, incense sticks, insecticides, repellents and blowing agents.

In a preferred embodiment of the (perfumed) product described in any of the embodiments above, the compound or mixture of two or more compounds of formula (I) as defined above is present in an amount of 0.01 to 10 wt.-%, preferably 0.01 to 7 wt.-%, with respect to the total weight of the product.

This amount represents a sensorially effective amount, in which the compound or mixture of two or more compounds of formula (I) is able to provide a pleasant sensory effect and the product is perceived as having a desired fragrance.

In one embodiment, the (perfumed) product described above comprises one or more additive(s), excipient(s) and/or active substances.

The additives, excipients and/or active substances are preferably not fragrance substances and, are preferably selected from the group consisting of: preservatives, preferably those mentioned in US 2006/0089413, abrasives, anti-acne agents and sebum reducing agents, preferably those mentioned in WO 2008/046791, anti-aging agents, preferably those mentioned in WO 2005/123101, antibacterial agents, anti-cellulite agents, anti-dandruff agents, preferably those mentioned in WO 2008/046795, anti-inflammatory agents, irritation-preventing agents, anti-irritants (anti-inflammatory, irritation-inhibiting and irritation-preventing agents), preferably those mentioned in WO 2007/042472 and US 2006/0089413, antimicrobial agents, preferably those mentioned in WO 2005/123101, antioxidants, preferably those mentioned in WO 2005/123101, astringents, antiseptic agents, antistatic agents, binders, buffers, carrier materials, preferably those mentioned in WO 2005/123101, chelating agents, preferably those mentioned in WO 2005/123101, cell stimulants, cleansing agents, caring agents, depilatories, surfactants, deodorizing agents and antiperspirants, preferably those mentioned in WO 2005/123101, plasticizers, emulsifiers, preferably those mentioned in WO 2005/123101, enzymes, essential oils, preferably those mentioned in US 2008/0070825, insect repellents, preferably those mentioned in WO 2005/123101, fibres, film-forming agents, (further) fixers, foaming agents, foam stabilisers, substances for the prevention of foaming, foam boosters, fungicides, gelling agents and gel-forming agents, preferably those mentioned in WO 2005/123101, hair care products, hair deforming agents, hair straightening agents, moisture regulators (moisturising and/or wetting agents and/or humectants), preferably those mentioned in WO 2005/123101, osmolytes, preferably those mentioned in WO 2005/123101, compatible solutes, preferably those mentioned in WO 01/76572 and WO 02/15686, bleaching agents, strengthening agents, stain removing agents, optical brightening agents, impregnating agents, soil repellents, friction reducing agents, lubricants, moisturizing creams, ointments, opacifiers, plasticising agents, covering agents, polish, brighteners, polymers, preferably those mentioned in WO 2008/046676, powders, proteins and protein hydrolysates, preferably those mentioned in WO 2005/123101 and WO 2008/046676, refattening agents, abrasive agents, skin-soothing agents, skin-cleansing agents, skin-care agents, skin repair agents, preferably containing cholesterol and/or fatty acids and/or ceramides and/or pseudoceramides, thereby preferably those mentioned in WO 2006/053912, skin whitening agents, preferably those mentioned in WO 2007/110415, skin protecting agents, skin softeners, skin cooling agents, preferably those mentioned in WO 2005/123101, skin warming agents, preferably those mentioned in WO 2005/123101, stabilisers, UV-absorbing agents and UV-filters, preferably those mentioned in WO 2005/123101, benzylidene-beta-dicarbonyl compounds, preferably those mentioned in WO 2005/107692, alpha-benzoyl cinnamic acid nitriles, preferably those mentioned in WO 2006/015954, AhR receptor antagonists, preferably those mentioned in WO 2007/128723 and WO 2007/060256, detergents, fabric softeners, suspending agents, skin tanning agents, preferably those mentioned in WO 2006/045760, thickeners, vitamins, preferably those mentioned in WO 2005/123101, fatty oils, waxes and fats, preferably those mentioned in WO 2005/123101, phospholipids, preferably those mentioned in WO 2005/123101, fatty acids (saturated fatty acids, mono- or polyunsaturated fatty acids, α-hydroxy acids, polyhydroxy fatty acids), preferably those mentioned in WO 2005/123101, dyes and colour protecting agents as well as pigments, preferably those mentioned in WO 2005/123101, anticorrosives, alcohols and polyols, preferably those mentioned in WO 2005/123101, surfactants, preferably those mentioned in WO 2005/123101, animal extracts, yeast extracts, extracts of algae or microalgae, electrolytes, liquefiers, organic solvents, preferably those mentioned in WO 2005/123101, hair growth modulating agents (hair growth promoting or hair growth inhibiting), preferably those mentioned in EP 2168570 and EP 2193785 or silicones and silicone derivatives, preferably those mentioned in WO 2008/046676, preferably selected from the group consisting of preservatives, inorganic salts, chelating agents, surfactants, skin and/or hair caring agents, enzymes, emulsifiers, fats, fatty oils, waxes, fatty alcohols, silicones, silicone derivatives and water.

In a further aspect, the present invention relates to a method of producing a perfumed product, preferably a product as described in any of the embodiments above, comprising the steps:
(i) providing one or a mixture of two or more compounds of formula (I) as defined above or a fragrance composition as defined above,
(ii) providing the further components of the perfumed product, and
(iii) contacting the further components of the perfumed product provided in step (ii) with a sensorially effective amount of one or a mixture of two or more compounds of formula (I) as defined above or a fragrance composition as defined above.

A “sensorially effective amount” refers to a total amount of the compound or mixture of compounds, which exerts a sensorial effect. The sensorial effect can be imparting, enhancing and/or modifying certain olfactory notes and/or masking and/or reducing unpleasant notes. Thus, a sensorially effective amount is an amount, in which the sensorial effect of the compound or mixture of compounds can be perceived in the product by a user in comparison to a product, which does not comprise the compound or mixture of compounds. Suitable amounts to provide this effect are given above in the context of the product.

Finally, the present invention also relates to a method of producing a compound of formula (I) as defined above, comprising the step:
(i) reacting a diazo compound of formula (II)

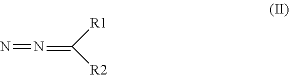

wherein R1=COOX with X=methyl, ethyl or tert-butyl, and
R2=H or methyl
with an alkene of formula (III)

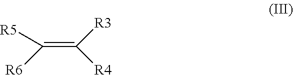

wherein R3 to R6 are defined as shown in the resulting compounds (1) to (15), (17) to (31) and (33) to (34) as defined above or wherein R³ to R6 are defined as shown in the resulting compounds (35) and (36)

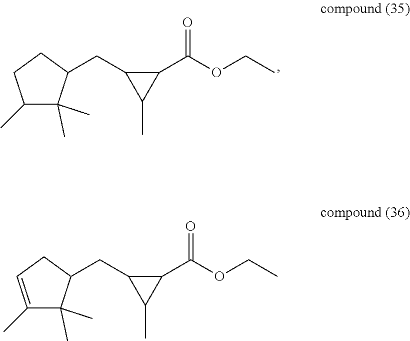

in the presence of a rhodium complex to form a compound selected from the group consisting of compounds (1) to (15), (17) to (31) and (33) to (36), and
in case compound (35) or (36) is formed in step (i), comprising the further step (ii) reducing the compound (35) or (36) to form compound (16) or compound (32) as defined above.

Surprisingly, it was found out that the above reaction can be successfully used to produce complex fragrance compounds, in particular the ones defined herein. Since the reaction is catalyzed, it can conveniently be performed at room temperature and does not require heating. Moreover, it was surprising that the reactions can be applied to such a variety of compounds with complex stereochemical properties and different substituents and therefore significantly broaden the range of accessible cyclopropanated fragrance compounds.

In a preferred embodiment of the method of producing a compound of formula (I) described above, the rhodium complex is a rhodium (II) complex with carboxylate ligands, in particular dirhodium (II) tetrakistriphenylacetate.

A number of suitable rhodium (II) complex with carboxylate ligands are known to the skilled person. In particular, dirhodium (II) tetrakistriphenylacetate has provided good results but other rhodium (II) complex with carboxylate ligands work as well.

Advantageously, as mentioned above, the reaction can be performed at around room temperature without requiring any heating steps. In a preferred embodiment, the reaction in step (i) is performed at a temperature between 1° and 30° C., preferably 15 to 25° C.

A suitable solvent for the reaction preformed in step (i) is dichlormethane. Other solvents for the reaction may be chlorinated and non-chlorinated alkanes, e.g. hexane, cycloalkanes, e.g. cyclohexane and aromatic solvents, e.g. toluene.

In a further preferred embodiment of the method of producing a compound of formula (I) described above, the reaction product is purified by distillation.

Distillation of the compounds of formula (I) as defined above to purify them from the reaction mixture provides good yields and a high purity, which cannot necessarily be achieved by other methods.

In a further preferred embodiment of the method of producing a compound of formula (I) described above, the reduction step (ii) is performed by reacting the compound (35) or (36) with LiAlH₄, AlH₃ or Li(Et)₃BH.

Finally, the present invention also provides novel cyclopropanated compounds with a pleasant fragrance. The compounds (3), (4), (7), (15), (16), (17), (19), (20), (21), (23), (24), (25), (26), (27), (28), (29), (30), (32), (33) and (34) as defined above have not been previously disclosed in the prior art.

The present invention therefore also relates to a compound or mixture of two or more compounds selected from the group consisting of compound (3), compound (4), compound (7), compound (15), compound (16), compound (17), compound (19), compound (20), compound (21), compound (23), compound (24), compound (25), compound (26), compound (27), compound (28), com-pound (29), compound (30), compound (32), compound (33) and compound (34).

The invention is further characterized by the following examples.

### Analytical Instruments and Materials

### Nuclear Magnetic Resonance Spectroscopy (NMR)

All NMR spectra were recorded at room temperature on a BRUKER Avance 400 (400 MHz). Deuterated chloroform acquired from EURISOTOP was used as solvent in all measurements. The chemical shifts δ are displayed relative to the peaks of residual chloroform (1H: 7.26 ppm, 13C: 77.2 ppm). The following abbreviations were used to describe the proton splitting pattern: d=doublet, t=triplet, q=quartet, m=multiplet, td=triplet of duplets, br=broad etc. and the corresponding coupling constants are given in Hertz (Hz). The signals of new compounds were assigned with two-dimensional Correlated Spectroscopy (COSY), Heteronuclear Single Quantum Coherence (HSQC) and Heteronuclear Multiple Bond Correlation (HMBC).

### Thin-Layer Chromatography (TLC)

All reactions were monitored by thin-layer chromatography (TLC) using silica-coated aluminum plates (MERCK, silica 60, F254). Seebach solution was used as TLC-stain in every case.

### Gas Chromatography Mass-Spectrometry (GC-MS)

Gas chromatography mass-spectrometry (GC-MS) measurements were performed on an Agilent Technologies model 6890N (electron impact ionization), equipped with an Agilent 19091S-433 column (5% methyl phenyl siloxane, 30 m, 0.25 μm) and a 5975B VL MSD detector with a turbopump. Helium was used as carrier gas. Diastereomeric ratios (d.r.) were determined by integration of the corresponding signals from the spectra of the crude products

### Infrared Spectroscopy (IR)

Infrared spectra were recorded on a Bruker Alpha ATR with the technique of attenuated total reflection (ATR). The positions of the absorption bands are given in wavenumbers ũ [cm-1] and classified in dependence of the absorption strength with the following abbreviations: vs (very strong, 0-9%), s (strong, 10-39%), m (medium, 40-69%), w (weak, 70-89%), vw (very weak, 90-100%).

### Mass Spectrometry

Electrospray ionization (ESI) experiments were recorded on a Thermo Fisher Q-Exactive (Orbitrap) mass spectrometer equipped with a HESI II probe to record high resolution. Spectra were interpreted by molecular peaks [M]+, peaks of protonated molecules [M+H]+ and characteristic fragment ion peaks. The signals are given in mass to charge ratio (m/z). In case of high-resolution measurements, the maximum tolerated error is ±5 ppm.

### Solvents and Chemicals

Commercially available solvents and chemicals (purchased from Fisher, Carl Roth, abcr, Alfa Aesar, TCI, Sigma Aldrich, VWR Chemicals, Fluka, Bernd Kraft) were used without further purification unless noted otherwise. For air- and moisture sensitive reactions, anhydrous solvents were obtained via a solvent purification system from MBraun and stored in Schlenk flasks over molecular sieves under an inert atmosphere of argon. Educts for cyclopropanation reactions obtained from Symrise AG were used without further purification.

### Working Techniques

Cold baths composed of water/ice (0° C.) or sodium chloride/ice (−21° C.) were used to cool reaction mixtures. Reactions were monitored by TLC and GC-MS. Crude compounds were purified by column chromatography. Quartz sand (baked out and washed with hydrochloric acid) and silica (Merck silica gel 60, 0.040×0.063 mm, 260-400 mesh ASTM) were used. Solvents were measured volumetrically. All glassware was oven-dried before use. Liquids were added with stainless-steel cannulas in single-use plastic syringes. The slow addition of liquids was performed with a Sage Instruments syringe pump model 341B and with a Landgraf Laborsysteme model LA100 syringe pump. Solvents were evaporated under reduced pressure at 40° C. using a rotary evaporator.

### Example 1: Synthesis of Dirhodium(II) Tetrakistriphenylacetate (Rh₂(TPA)₄)

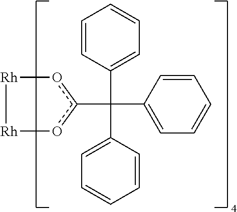

The compound was prepared following the method described by Du Bois. [1] Rh₂(OAc)₄ (150 mg, 339 μmmol, 1.0 equiv.) and 2,2,2-triphenylacetic acid (782.8 mg, 2.72 mmol, 8.0 equiv.) were suspended in anhydrous chlorobenzene (38 mL) and the flask was equipped with a short-path distillation apparatus. The mixture was heated to 135° C. at which the solvent was distilled off at a rate of 5 mL/h. After 4 h the mixture was cooled to room temperature and diluted with dichloromethane (20 mL). The mixture was washed with sat. aq. NaHCO₃ (3×40 mL) and with sat. aq. NaCl (50 mL). The organic layer was separated and dried over Na₂SO₄. Evaporation of the solvent under reduced pressure yielded the crude product as a dark green solid which was dissolved in dichloromethane (5 mL) and purified by column chromatography (DCM/EtOAc, 3:1). The title compound was obtained after drying in vacuo at 80° C. for 8 h as a deep green solid (382 mg, 282 μmol, 83%). It was found coordinated with one equivalent of ethyl acetate which can be removed by further heating.

R_{f}=0.98 (DCM/EtOAc, 3:1).

¹H NMR (400 MHz, CDCl₃, ppm) δ=7.00 (t, J=7.3 Hz, 12H, H_{Ar}), 6.79 (t, J=7.7 Hz, 24H, H_{Ar}), 6.55 (d, J=7.9 Hz, 24H, H_{Ar}).

The analytical data match those reported in the literature. [1]

### Example 2: Synthesis of Diazocompounds

### General Procedure for the Synthesis of Diazo Esters

Diazo esters were prepared by a slight modification of the method described by Searle. [2] The corresponding amino acid ester hydrochloride (79.6 mmol, 1 equiv.) was dissolved in water (25 mL) and dichloromethane (60 mL) in a three-necked flask equipped with an argon inlet, a thermometer and a dropping funnel. The flask was flooded with argon and cooled to −5° C. An ice-cold solution of sodium nitrite (95.6 mmol, 1.2 equiv.) in water (25 mL) was added dropwise under stirring while the temperature was maintained at −5° C. After completion of the addition the temperature was lowered to −9° C. and sulfuric acid (5% aq. solution, 9.5 mL) was added at such a rate the temperature does not exceed 0° C. The reaction terminates within 15 minutes as no longer heat evolves.

The organic layer was separated and run into cold NaHCO3 (5% aq. solution, 100 mL). The aqueous layer was extracted with dichloromethane (10 mL). The combined organic layers and NaHCO₃ solution were shaken vigorously until no trace of acid remained. The yellow organic layer was separated and dried over Na2SO4. The solvent was removed under reduced pressure to obtain the title compound which was used without further purification. Evaporation of the solvent has to be done with care as diazo esters may be explosive under heating.

### tert-Butyl 2-diazopropanoate

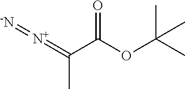

The title compound was prepared according to the general procedure starting from L-alanine tert-butyl ester hydrochloride (1.82 g, 10 mmol). The title compound (1.36 g, 8.71 mmol, 87%) was obtained as a yellow oil.

R_{f}=0.34 (n-pentane/Et₂O, 30:1).

¹H NMR (400 MHz, CDCl₃, ppm) δ=1.68 (s, 3H, CH₃), 1.47 (s, 9H, C(CH₃)₃).

### Methyl 2-diazoacetate

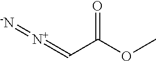

The title compound was prepared according to the general procedure starting from glycine methyl ester hydrochloride (10.0 g, 79.6 mmol). The title compound (4.35 g, 43.5 mmol, 55%) was obtained as a yellow oil.

R_{f}=0.35 (n-pentane/Et₂O, 30:1)

¹H NMR (400 MHz, CDCl₃, ppm) δ=4.74 (s, 1H, CHN₂), 3.75 (s, 3H, CH₃).

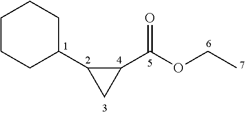

### Example 3: Synthesis of Cyclopropanated Compounds

### General Procedure for the Cyclopropanation of Alkenes

In a Schlenk flask the corresponding alkene (1 equiv.) and Rh₂(TPA)₄ (1 mol %) were dissolved in dichloromethane (0.2 M) at 20° C. To this solution the diazo ester in dichloromethane (0.4 M) was added at a rate of 1 mL/h. After the addition the solution was stirred overnight. The solvent was removed in vacuo and the residue was purified by column chromatography to obtain the cyclopropyl compound.

### Ethyl 2-cyclohexylcyclopropane-1-carboxylate (Compound (1))

The title compound was prepared according to the general procedure starting from vinylcyclohexane (250 mg, 2.27 mmol) and Rh₂(TPA)₄ (30.7 mg, 23.0 μmol) in dichloromethane (11.3 mL) and ethyl diazoacetate (1.19 g, 9.08 mmol, 4.0 equiv.) in dichloromethane (22.7 mL). The crude product was purified by column chromatography (n-pentane/Et₂O, 30:1) to obtain the title compound (335 mg, 1.71 mmol, 75%) as a colorless oil.

d.r.=1:1.2

R_{f}=0.43, 0.47 (n-pentane/Et₂O, 30:1).

GC-MS (5% methyl phenyl siloxane, 30 m, 0.25 μm, He): t_{R1}=9.104 min (45%, [M]⁺ 196.1), t_{R2}=9.376 min (55%, [M]⁺ 196.1).

¹H NMR (400 MHz, CDCl₃, ppm) δ=4.12-3.98 (m, 2H, C6-H₂), 1.77-1.50 (m, 5H, 5×CH_{Cy}), 1.31 (dt, J=8.5, 4.4 Hz, 1H, C4-H), 1.19 (dt, J=7.1, 3.6 Hz, 3H, C7-H₃), 1.16-0.92 (m, 7H, 5×CH_{Cy}, C2-H, C3-H), 0.69-0.54 (m, 2H, C1-H, C3-H).

¹³C NMR (101 MHz, CDCl₃, ppm) δ=174.86 (C5), 173.37 (C5), 60.39 (C6), 60.33 (C6), 41.77 (C1), 32.79, 32.58 (2×CH_{2 Cy}), 29.47 (C2), 26.52, 26.26, 26.08, (3×CH_{2 Cy}) 19.10 (C4), 14.41 (C7), 14.31 (C3).

IR (ATR, cm⁻¹) \tilde{v}=2980 (w), 2922 (s), 2850 (m), 1806 (vw), 1800 (vw), 1793 (vw), 1724 (vs), 1656 (w), 1618 (w), 1601 (w), 1591 (w), 1571 (w), 1562 (w), 1557 (w), 1541 (w), 1514 (w), 1477 (w), 1448 (s), 1407 (m), 1373 (m), 1358 (w), 1349 (w), 1330 (m), 1300 (w), 1279 (w), 1264 (m), 1237 (w), 1201 (m), 1174 (vs), 1159 (vs), 1115 (m), 1096 (m), 1084 (m), 1037 (s), 996 (m), 977 (w), 941 (m), 892 (w), 853 (m), 830 (m), 795 (w), 788 (w), 747 (w), 714 (w), 694 (w), 681 (w), 645 (w), 622 (w), 609 (w), 599 (w), 579 (w), 567 (w), 554 (w), 537 (w), 514 (w), 492 (w), 482 (w), 477 (w), 458 (w), 443 (w), 435 (w), 428 (w), 421 (w), 411 (w), 407 (w), 391 (w), 381 (w).

HRMS (ESI⁺, [M+H]⁺, C₁₂H₂₁O₂⁺) calcd.: 197.1537. found: 197.1534.

The analytical data match those reported in the literature. (Shaw, Croft, Whittingham, & Bower, 2015)

### Ethyl 1-methylbicyclo[3.1.0]hexane-6-carboxylate (Compound (2))

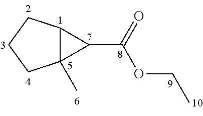

The title compound was prepared according to the general procedure starting from 1-methylcyclopentene (100 mg, 1.22 mmol) and Rh₂(TPA)₄ (16.5 mg, 12.0 μmol) in dichloromethane (6.1 mL) and ethyl diazoacetate (640 mg, 4.87 mmol, 4.0 equiv.) in dichloromethane (12.2 mL). The crude product was purified by column chromatography (n-pentane/Et₂O, 30:1) to obtain the title compound (145 mg, 859 μmol, 71%) as a colorless oil.

d.r.=1:1.1

R_{f}=0.43, 0.48 (n-pentane/Et₂O, 30:1).

GC-MS (5% methyl phenyl siloxane, 30 m, 0.25 μm, He): t_{R1}=7.2 min (48%, [M]⁺ 168.1), t_{R2}=7.49 min (52%, [M]⁺ 168.1).

¹H NMR (400 MHz, CDCl₃, ppm) δ=4.10-3.99 (m, 2H, C9-CH₂), 1.98-1.47 (m, 6H, 3×CH_{2 Cp}), 1.42 (d, J=3.5 Hz, 1H, C7-CH), 1.26 (s, 3H, C6-CH₃), 1.22-1.20 (m, 1H, C1-CH), 1.18 (dd, J=7.2, 2.1 Hz, 3H, C10-CH₃).

¹³C NMR (101 MHz, CDCl₃, ppm) δ=173.07 (C8), 171.84 (C8), 60.23 (C9), 60.17 (C9), 42.47, 41.49, 41.01, 36.32, 36.22, 35.58, 35.23, 33.87, 33.65, 33.12, 32.52, 32.07, 30.65, 30.43, 29.20, 28.05 (C_{Cpr}), 27.81, 26.64, 26.12 (C_{Cpr}), 24.50, 23.97, 22.76, 22.71, 21.02, 20.58, 19.58, 18.90, 16.72, 15.09 (C6), 14.54, 14.46, 14.42, 14.25 (C_{Cpr}).

IR (ATR, cm⁻¹) \tilde{v}=2934 (w), 2864 (w), 1721 (vs), 1655 (w), 1601 (Vw), 1584 (vw), 1554 (vw), 1543 (vw), 1446 (m), 1415 (m), 1383 (w), 1367 (m), 1344 (m), 1313 (w), 1302 (w), 1272 (m), 1261 (w), 1222 (s), 1205 (m), 1174 (vs), 1163 (vs), 1149 (vs), 1092 (vs), 1051 (s), 1038 (vs), 1009 (m), 963 (m), 921 (w), 902 (w), 890 (w), 854 (m), 815 (w), 766 (w), 734 (w), 721 (w), 669 (w), 649 (w), 623 (w), 609 (w), 595 (w), 585 (w), 574 (w), 552 (w), 520 (w), 511 (w), 490 (w), 472 (w), 458 (w), 445 (w), 436 (w), 429 (w), 418 (w), 404 (w), 395 (w), 385 (w), 380 (w).

HRMS (ESI⁺, [M+H]⁺, C₁₀H₁₇O₂⁺) calcd: 169.1223. found: 169.1218.

### Ethyl 2-methyl-3-pentylcyclopropane-1-carboxylate (Compound (18))

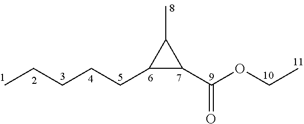

The title compound was prepared according to the general procedure starting from trans-2-octene (200 mg, 1.78 mmol) and Rh₂(TPA)₄ (24.5 mg, 18.0 μmol) in dichloromethane (8.9 mL) and ethyl diazoacetate (935 mg, 7.13 mmol, 4.0 equiv.) in dichloromethane (17.8 mL). The crude product was purified by column chromatography (n-pentane/Et₂O, 30:1) to obtain the title compound (292 mg, 1.47 mmol, 83%) as a colorless oil.

d.r.=1:1.9

R_{f}=0.34 (n-Pentane/Et₂O 30:1).

GC-MS (5% methyl phenyl siloxane, 30 m, 0.25 μm, He): t_{R1}=8.390 min (39%, [M]⁺ 198.1) t_{R2}=8.529 min (61%, [M]⁺ 198.1).

¹H NMR (400 MHz, CDCl₃, ppm) δ=4.18-4.04 (m, 2H, C10-CH₂), 1.47-0.92 (m, 17H, including 0.88 (m, 1H, H_{Cpr}), 0.91-0.82 (m, 3H, C1-CH₃).

¹³C NMR (101 MHz, CDCl₃, ppm) δ=173.10, 173.02 (C9), 60.18 (C10), 34.27, 33.23, 31.65, 31.15, 29.41, 29.11, 28.80 (C_{Cpr}), 26.81, 26.51, 25.84, 23.83, 22.78 (C_{Cpr}), 22.75, 22.48, 22.33, 18.13, 14.54, 14.52, 14.18 (C_{Cpr}), 12.20.

IR (ATR, cm⁻¹) \tilde{v}=2979 (w), 2956 (w), 2924 (m), 2871 (w), 2856 (w), 1723 (vs), 1656 (w), 1649 (vw), 1639 (vw), 1629 (vw), 1619 (vw), 1612 (vw), 1605 (vw), 1596 (vw), 1585 (vw), 1578 (vw), 1571 (vw), 1561 (vw), 1547 (vw), 1534 (vw), 1527 (vw), 1523 (vw), 1507 (vw), 1458 (m), 1445 (m), 1373 (m), 1349 (m), 1317 (w), 1302 (w), 1265 (w), 1235 (w), 1174 (vs), 1163 (vs), 1126 (m), 1112 (m), 1096 (s), 1071 (m), 1044 (s), 990 (w), 948 (w), 897 (w), 880 (w), 856 (m), 839 (w), 819 (w), 807 (w), 789 (w), 766 (w), 745 (w), 724 (w), 684 (w), 664 (w), 647 (w), 637 (w), 626 (w), 613 (w), 606 (w), 596 (w), 586 (w), 575 (w), 567 (w), 558 (w), 537 (w), 521 (w), 499 (w), 486 (w), 473 (w), 466 (w), 453 (w), 445 (w), 432 (w), 424 (w), 416 (w), 408 (w), 399 (w), 391 (w).

HRMS (ESI⁺, [M+H]⁺, C₁₂H₂₃O₂⁺) calcd: 199.1693. found: 199.1690.

The analytical data match with those reported in the literature (Barrett, Braddock, Lenoir, & Tone, 2001).

### Ethyl 2-(3,5-dimethylhexyl-4-en-1-yl)cyclopropane-1-carboxylate (Compound (3))

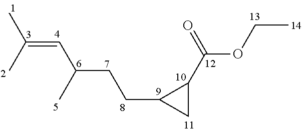 [SMILES: CCOC(=O)C1CC1CCC(C)C=C(C)C]

The title compound was prepared according to the general procedure starting from 5,7-dimethylocta-1,6-diene (160 mg, 1.16 mmol) and Rh₂(TPA)₄ (14.7 mg, 11.0 μmol) in dichloromethane (5.8 mL) and ethyl diazoacetate (396 mg, 3.47 mmol, 3.0 equiv.) in dichloromethane (8.7 mL). The crude product was purified by column chromatography (n-pentane/Et₂O, 30:1) to obtain the title compound (214 mg, 953 μmol, 82%) as a colorless oil.

d.r.=1:1.3

R_{f}=0.45, 0.55 (n-Pentane/Et₂O 30:1).

GC-MS (5% methyl phenyl siloxane, 30 m, 0.25 μm, He): t_{R1}=9.673 min (44%, [M]⁺ 224.1), t_{R2}=9.829 min (56%, [M]⁺ 224.1).

¹H NMR (400 MHz, CDCl₃, ppm) δ=4.89-4.81 (m, 1H, C4-H), 4.16-4.04 (m, 2H, C13-CH₂), 2.36-2.25 (m, 1H, C6-H), 1.66 (s, 3H, C1-CH₃), 1.58 (s, 3H, C2-CH₃), 1.55-1.35 (m, 2H, C8-CH₂), 1.34-1.29 (m, 1H, H_{Cpr}), 1.28-1.26 (m, 2H, C7-CH₂), 1.26-1.22 (m, 3H, C14-CH₃), 1.21-1.16 (m, 1H, H_{Cpr}), 1.01-0.92 (m, 1H, H_{Cpr}), 0.90-0.87 (m, 3H, C5-CH₃), 0.71-0.61 (m, 1H, H_{Cpr}).

¹³C NMR (101 MHz, CDCl₃, ppm) δ=173.19 (C12), 173.13 (C12), 131.52 (C4), 131.45 (C4), 60.41 (C13), 60.33 (C13), 37.85, 37.23, 32.41, 32.29 (C6), 32.25 (C6), 31.13 (C_{Cpr}), 29.21 (C_{Cpr}), 27.82, 25.92, 25.25, 25.17, 23.20, 22.77, 22.20, 22.13, 21.45, 21.30, 20.59, 20.40 (C_{Cpr}), 20.30 (C_{Cpr}), 19.58, 18.43, 18.07, 15.74 (C_{Cpr}), 15.62 (C_{Cpr}), 14.52, 14.43, 14.26, 13.49, 13.43.

IR (ATR, cm⁻¹) \tilde{v}=2959 (w), 2917 (w), 2867 (w), 1725 (vs), 1656 (vw), 1649 (vw), 1630 (vw), 1623 (vw), 1611 (vw), 1605 (vw), 1591 (vw), 1584 (vw), 1572 (vw), 1561 (vw), 1543 (vw), 1534 (vw), 1523 (vw), 1509 (vw), 1448 (m), 1405 (m), 1378 (m), 1354 (w), 1332 (w), 1300 (w), 1265 (w), 1225 (w), 1162 (vs), 1096 (m), 1082 (m), 1068 (m), 1045 (m), 984 (m), 969 (w), 938 (w), 857 (m), 830 (m), 775 (w), 758 (w), 728 (w), 679 (w), 669 (w), 646 (w), 639 (w), 632 (w), 623 (w), 609 (w), 596 (w), 581 (w), 569 (w), 555 (w), 545 (w), 533 (w), 514 (w), 501 (w), 484 (w), 476 (w), 453 (w), 439 (w), 426 (w), 418 (w), 412 (w), 402 (w), 395 (w), 380 (w).

HRMS (ESI⁺, [M+H]⁺, C₁₄H₂₅O₂⁺) calcd: 225.1849. found: 225.1845.

### Ethyl 2-(6-methylhept-5-en-2-yl)cyclopropane-1-carboxylate (Compound (4))

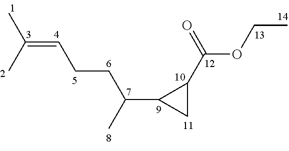 [SMILES: CCOC(=O)C1CC1C(C)CCC=C(C)C]

The title compound was prepared according to the general procedure starting from 3,7-dimethylocta-1,6-diene (150 mg, 1.09 mmol) and Rh₂(TPA)₄ (14.7 mg, 11.0 μmol) in dichloromethane (5.4 mL) and ethyl diazoacetate (356 mg, 2.71 mmol, 2.5 equiv.) in dichloromethane (6.8 mL). The crude product was purified by column chromatography (n-pentane/Et₂O, 30:1) to obtain the title compound (76 mg, 339 μmol, 31%) as a colorless oil.

d.r.=1:1.2:2.4:3.7:3.6

R_{f}=0.4, 0.53, 0.66 (n-Pentane/Et₂O 30:1).

GC-MS (5% methyl phenyl siloxane, 30 m, 0.25 μm, He): t_{R1}=8.981 min (8.1%, M⁺-CH₃ 209.2), t_{R2}=9.106 min (9.5%, M⁺-CH₃ 209.2), t_{R3}=9.617 min (20.3%, M+224.2), t_{R4}=9.798 min (31.8%, M+224.2), t_{R5}=9.944 min (30.2%, M⁺ 224.2).

¹H NMR (400 MHz, CDCl₃, ppm) δ=5.15-4.85 (m, 1H, C4-CH), 4.20-4.02 (m, 2H, C13-CH₂), 2.15-1.87 (m, 2H, C5-CH₂), 1.71-0.65 (m, 19H).

¹³C NMR (101 MHz, CDCl₃, ppm) δ=174.88, 174.67, 173.34, 173.18 (C12), 144.61, 131.53, 131.29, 124.99, 124.94, 124.73 (C4), 112.89, 112.74 (C3), 60.42 (C13), 60.36, 60.24, 60.18, 59.75, 41.69, 37.79, 37.73, 37.65, 37.18, 37.04, 36.94, 36.88, 36.81, 36.58, 36.46, 34.13, 33.81, 33.29, 33.18, 33.12, 31.51, 30.96, 29.79, 29.63, 29.31, 29.24, 28.76, 26.56, 25.90, 25.83 (C5), 25.79 (C1/C2), 25.68, 25.49, 21.34, 21.22, 21.13, 21.06, 20.52, 20.41, 20.26, 20.12, 19.75, 19.63, 19.57, 19.42, 19.18, 18.98, 17.77 (C1/C2), 17.69, 15.57, 14.63, 14.53, 14.48, 14.41, 13.99, 13.81, 12.48.

IR (ATR, cm⁻¹) \tilde{v}=2956 (w), 2925 (w), 2917 (w), 2871 (w), 1724 (vs), 1448 (m), 1405 (w), 1377 (m), 1346 (w), 1300 (w), 1265 (w), 1237 (w), 1163 (vs), 1113 (m), 1095 (m), 1079 (m), 1038 (m), 983 (w), 925 (w), 858 (m), 830 (m), 795 (w), 785 (w), 745 (w), 728 (w), 681 (w), 664 (w), 636 (w), 626 (w), 609 (w), 599 (w), 591 (w), 572 (w), 561 (w), 552 (w), 543 (w), 524 (w), 507 (w), 500 (w), 490 (w), 482 (w), 475 (w), 448 (w), 429 (w), 411 (w), 402 (w), 397 (w), 385 (w), 378 (w).

HRMS (ESI⁺, [M+H]⁺, C₁₄H₂₅O₂⁺) calcd: 225.1849. found: 225.1846.

### Ethyl 2-(6-methylhepta-1,5-dien-2-yl)cyclopropane-1-carboxylate (Compound (5))

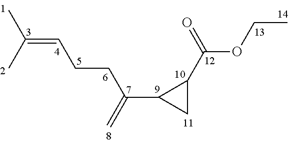 [SMILES: C=C(CCC=C(C)C)C1CC1C(=O)OCC]

The title compound was prepared according to the general procedure starting from 7-methyl-3-methylidene-octa-1,6-diene (150 mg, 1.10 mmol) and Rh₂(TPA)₄ (14.9 mg, 11.0 μmol) in dichloromethane (5.5 mL) and ethyl diazoacetate (290 mg, 2.20 mmol, 2.0 equiv.) in dichloromethane (5.5 mL). The crude product was purified by column chromatography (n-pentane/Et₂O, 30:1) to obtain the title compound (128 mg, 575 μmol, 53%) as a colorless oil.

d.r.=1.5:1:3.2

R_{f}=0.33, 0.4, 0.5 (n-Pentane/Et₂O, 30:1).

GC-MS (5% methyl phenyl siloxane, 30 m, 0.25 μm, He): t_{R1}=9.588 min (26.2%, [M]⁺ 222.1), 9.820 min (17.4%, [M]⁺ 222.1), 10.080 min (56.3%, [M]⁺ 222.1).

¹H NMR (400 MHz, CDCl₃, ppm) δ=5.86-5.61 (m, 1H, C4-CH), 5.21-4.91 (m, 2H, C8-CH₂), 4.18-4.03 (m, 2H, C13-CH₂), 2.32-1.91 (m, 4H, C5-CH₂, C6-CH₂), 1.87-0.79 (m, 13H).

¹³C NMR (101 MHz, CDCl₃, ppm) δ=173.97, 172.04, 171.45 (C12), 147.59, 143.60 (C3), 141.85 (C4), 136.81, 131.79, 131.64, 124.22, 124.18, 124.01, 123.93 (C7), 115.56, 113.08, 112.60, 108.79, 60.69, 60.64, 60.52, 60.40 (C13), 37.29, 37.19, 35.96, 32.85, 32.71, 29.90, 28.66, 27.49, 27.19, 26.69, 26.62, 26.46, 25.95, 25.82, 25.46, 21.62, 20.70, 20.46, 20.35, 17.84, 17.80, 17.72, 14.91, 14.52, 14.47, 14.42, 10.97.

IR (ATR, cm⁻¹) \tilde{v}=2978 (w), 2968 (w), 2925 (w), 2874 (w), 2859 (w), 1724 (vs), 1638 (w), 1595 (vw), 1445 (m), 1400 (m), 1380 (m), 1354 (w), 1336 (w), 1320 (w), 1265 (w), 1242 (w), 1162 (vs), 1096 (m), 1062 (m), 1040 (m), 990 (m), 897 (m), 857 (m), 843 (m), 834 (m), 799 (w), 783 (w), 758 (w), 742 (w), 717 (w), 694 (w), 677 (w), 666 (w), 653 (w), 645 (w), 637 (w), 630 (w), 623 (w), 616 (w), 581 (w), 568 (w), 552 (w), 545 (w), 538 (w), 523 (w), 507 (w), 484 (w), 476 (w), 453 (w), 443 (w), 432 (w), 424 (w), 414 (w), 404 (w), 391 (w), 384 (w).

HRMS (ESI⁺, [M+H]⁺, C₁₄H₂₃O₂⁺) calcd: 223.1693. found: 223.1689.

### Ethyl 1,1a,1b,2,5,5a,6,6a-octahydro-2,5-methanocyclopropa[α]indene-1-carboxylate (Compound (6))

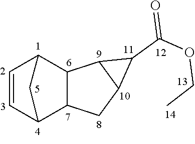 [SMILES: CCOC(=O)C1C2CC3C4C=CC(C4)C3C21]

The title compound was prepared according to the general procedure starting from dicyclopentadiene (150 mg, 1.14 mmol) and Rh₂(TPA)₄ (15.4 mg, 11.0 μmol) in dichloromethane (5.7 mL) and ethyl diazoacetate (372 mg, 2.84 mmol, 2.5 equiv.) in dichloromethane (7.1 mL). The crude product was purified by column chromatography (n-pentane/Et₂O, 30:1) to obtain the title compound (87 mg, 400 μmol, 35%) as a colorless oil. The compound needs further purification or separation of the isomers.

d.r.=1:1.5:1.6:3.6

R_{f}=0.16, 0.3, 0.34, 0.5 (n-pentane/Et₂O, 30:1).

GC-MS (5% methyl phenyl siloxane, 30 m, 0.25 μm, He): t_{R1}=10.787 min (13%, [M]⁺ 218.1), t_{R2}=11.070 min (19.4%, [M]⁺ 218.1), t_{R3}=11.149 min (21.2%, [M]⁺ 218.1), t_{R4}=11.287 min (46.4%, [M]⁺ 218.1).

¹H NMR (400 MHz, CDCl₃, ppm) δ=6.15 (ddd, J=22.1, 5.7, 2.8 Hz, 1H CH═CH), 5.78-5.63 (m, 1H, CH═CH), 4.15-4.02 (m, 2H, C13-CH₂), 2.93-2.89 (m, 1H), 2.88-2.83 (m, 1H), 2.81-2.70 (m, 1H, C5-CH₂), 2.68 (dd, J=8.2, 4.0 Hz, 1H, C5-CH₂), 2.45-2.40 (m, 1H), 1.75-1.69 (m, 1H), 1.61-1.57 (m, 1H), 1.50-1.45 (m, 1H), 1.44-1.28 (m, 2H), 1.27-1.20 (m, 3H), 1.04 (t, J=3.1 Hz, 1H).

¹³C NMR (101 MHz, CDCl₃, ppm) δ=174.50 (C12), 173.76 (C12), 138.82 (C2/C3), 138.36 (C2/C3), 136.02 (C2/C3), 135.64 (C2/C3), 135.27 (C2/C3), 134.57 (C2/C3), 134.53 (C2/C3), 60.60 (C13), 60.22 (C13), 60.13 (C13), 59.73, 56.38, 55.88, 55.54, 54.80, 54.52, 52.91, 51.96, 51.90, 49.88, 49.52, 48.88, 47.25, 47.04, 46.84, 46.53, 45.53, 45.47, 45.36, 45.27, 43.23, 42.83, 39.52, 38.34, 38.26, 34.53, 33.21, 32.98, 32.27, 32.06, 31.55, 31.48, 31.36, 30.42, 30.17, 29.70, 27.97, 27.12, 24.89, 24.00, 23.64, 23.52, 21.10, 20.08, 19.41, 16.10, 15.57, 14.41, 14.31, 14.08.

IR (ATR, cm⁻¹) \tilde{v}=2959 (m), 2932 (w), 2904 (w), 2867 (w), 1720 (vs), 1655 (w), 1649 (w), 1616 (w), 1572 (w), 1561 (w), 1551 (w), 1543 (w), 1534 (w), 1523 (w), 1509 (w), 1477 (w), 1451 (w), 1408 (s), 1385 (m), 1367 (w), 1347 (w), 1317 (m), 1286 (s), 1266 (s), 1237 (m), 1210 (w), 1160 (vs), 1095 (m), 1051 (s), 1031 (m), 1011 (s), 992 (m), 970 (m), 952 (w), 931 (w), 919 (w), 907 (w), 904 (w), 892 (w), 870 (m), 841 (s), 802 (w), 788 (m), 738 (s), 730 (s), 714 (s), 693 (m), 677 (w), 666 (w), 629 (w), 611 (w), 599 (w), 589 (w), 579 (w), 571 (w), 560 (w), 550 (w), 527 (w), 518 (w), 487 (w), 469 (w), 455 (w), 438 (w), 425 (w), 416 (w), 408 (w), 398 (w), 381 (w).

HRMS (ESI⁺, [M+H]⁺, C₁₄H₁₉O₂⁺) calcd: 219.1380. found: 219.1379.

### Ethyl 2-(2-ethoxy-2-oxoethyl)bicyclo[3.1.0]hexane-6-carboxylate (Compound (15))

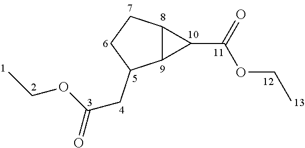 [SMILES: CCOC(=O)CC1CCC2C(C(=O)OCC)C12]

The title compound was prepared according to the general procedure starting from ethyl 2-(cyclopentene-2-en-1-yl)acetate (SULTANENE®, 100 mg, 649 μmol) and Rh₂(TPA)₄ (8.8 mg, 6.0 μmol) in dichloromethane (3.2 mL) and ethyl diazoacetate (85 mg, 649 μmol, 1.0 equiv.) in dichloromethane (1.6 mL). The crude product was purified by column chromatography (n-pentane/Et₂O, 3:1) to obtain the title compound (34 mg, 143 μmol, 30%) as a green oil. The compound needs additional purification.

d.r.=1:4.3:2.7

R_{f}=0.19, 0.21 (n-Pentane/Et₂O 10:1).

GC-MS (5% methyl phenyl siloxane, 30 m, 0.25 μm, He): t_{R1}=10.863 min (12.5%, [M]⁺ 240.1), t_{R2}=10,962 min (53.7%, [M]⁺ 240.1), t_{R3}=11.176 min (33.7%, [M]⁺ 240.1).

¹H NMR (400 MHz, CDCl₃, ppm) δ=4.17-4.05 (m, 4H, C2-CH₂, C13-CH₂), 2.70-2.17 (m, 3H, C4-CH₂, C5-CH), 2.04-1.34 (m, 7H, C6-CH₂, C7-CH₂, C8-CH, C9-CH, C10-CH), 1.29-1.22 (m, 6H, C1-CH₃, C13-CH₃).

¹³C NMR (101 MHz, CDCl₃, ppm) δ=173.88, 173.74, 172.93 (C3), 172.79, 172.61, 171.41 (C11), 165.39, 129.93, 61.37, 60.51 (C12), 60.43 (C2), 41.06, 39.63, 38.11, 36.88, 36.78, 35.68, 32.99, 32.40, 29.91, 29.60, 28.87, 28.59, 27.92, 27.33, 26.69, 26.25, 25.92, 25.21, 24.39, 24.25, 23.84, 22.96, 22.27, 19.12, 14.39, 14.31, 14.15.

IR (ATR, cm⁻¹) \tilde{v}=2979 (w), 2955 (w), 2939 (w), 2908 (w), 2871 (w), 1721 (vs), 1649 (w), 1596 (vw), 1561 (vw), 1551 (vw), 1541 (Vw), 1537 (vw), 1507 (vw), 1465 (w), 1446 (w), 1414 (m), 1388 (w), 1371 (m), 1332 (w), 1298 (m), 1258 (vs), 1163 (vs), 1150 (vs), 1113 (s), 1095 (s), 1031 (vs), 946 (w), 918 (w), 867 (w), 841 (m), 806 (w), 744 (w), 722 (m), 681 (w), 670 (w), 656 (w), 630 (w), 609 (w), 585 (w), 547 (w), 535 (w), 521 (w), 509 (w), 496 (w), 484 (w), 472 (w), 462 (w), 456 (w), 445 (w), 433 (w), 426 (w), 414 (w), 397 (w), 380 (w)

HRMS (ESI⁺, [M+Na]⁺, C₁₃H₂₀O₄Na) calcd: 263.1259. found: 263.1250.

### Ethyl 2-(2-acetoxy-6-methylhepten-5-en-2-yl)cyclopropane-1-carboxylate (Compound (25))

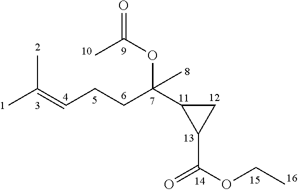 [SMILES: CCOC(=O)C1CC1C(C)(CCC=C(C)C)OC(C)=O]

The title compound was prepared according to the general procedure starting from 3,7-dimethylocta-1,6-dien-3-yl acetate (150 mg, 764 μmol) and Rh₂(TPA)₄ (10.4 mg, 8.0 μmol) in dichloromethane (3.8 mL) and ethyl diazoacetate (250 mg, 1.91 mmol, 2.5 equiv.) in dichloromethane (4.8 mL). The crude product was purified by column chromatography (n-pentane/Et₂O, 10:1) to obtain the title compound (81 mg, 287 μmol, 37%) as a green oil. The compound needs additional purification.

R_{f}=0.44, 0.54 (n-Pentane/Et₂O 10:1).

GC-MS (5% methyl phenyl siloxane, 30 m, 0.25 μm, He): t_{R1}=10.885 min ([M]⁺ 282.1).

¹H NMR (400 MHz, CDCl₃, ppm) δ=5.11-4.96 (m, 1H, C4-CH), 4.10-3.96 (m, 2H, C15-CH₂), 2.09-0.84 (m, 24H, including 2.06-1.94 (m, 2H, C5-CH₂), 1.62-1.44 (m, 6H, C1/C2-CH₃), 1.22-1.16 (m, 3H, C16-CH₃)).

¹³C NMR (101 MHz, CDCl₃, ppm) δ=174.23, 174.14, 172.95 (C14), 171.89, 171.85, 171.62, 170.03, 169.87 (C9), 142.06, 141.89, 141.76, 132.02, 131.90, 131.83, 124.05, 123.91, 123.82, 113.39, 113.32, 113.24 (C4), 83.21, 83.00, 82.94, 82.80, 81.99, 81.57, 81.49, 60.71 (C15), 60.26 (C15), 59.82, 40.10, 39.68, 39.64, 38.92, 38.85, 33.73, 33.32, 33.05, 30.50, 30.39, 30.12, 29.83, 29.22, 28.63, 25.80, 25.52, 23.96, 23.75, 23.70, 23.32, 23.14, 22.96, 22.86, 22.70, 22.65, 22.36, 22.30, 22.23, 22.08, 21.96, 21.22, 21.02, 19.84, 18.77, 17.78, 17.67, 17.62, 17.37, 16.63, 14.51, 14.40, 14.37, 14.24, 12.18, 10.97, 10.50 (C_{Cpr}).

IR (ATR, cm⁻¹) \tilde{v}=2976 (w), 2931 (w), 2873 (w), 1725 (vs), 1646 (w), 1596 (w), 1571 (w), 1561 (w), 1544 (w), 1536 (w), 1523 (w), 1507 (w), 1453 (m), 1449 (m), 1407 (w), 1367 (s), 1343 (w), 1324 (m), 1300 (w), 1241 (vs), 1176 (vs), 1111 (s), 1089 (s), 1020 (s), 943 (m), 929 (m), 891 (w), 858 (m), 837 (m), 798 (w), 773 (w), 748 (w), 720 (w), 700 (w), 694 (w), 666 (w), 656 (w), 649 (w), 609 (m), 567 (w), 555 (w), 544 (w), 537 (w), 527 (w), 518 (w), 513 (w), 482 (w), 452 (w), 438 (w), 422 (w), 411 (w), 388 (w), 378 (w).

HRMS (ESI⁺, [M+Na]⁺, C₁₆H₂₆O₄Na) calcd: 305.1729. found: 305.1721.

### Ethyl 2-(6-acetoxy-6-methylheptan-2-yl)cyclopropane-1-carboxylate (Compound (23))

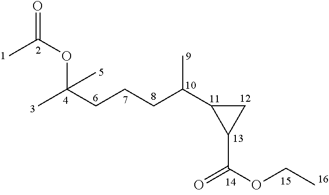 [SMILES: CCOC(=O)C1CC1C(C)CCCC(C)(C)OC(C)=O]

The title compound was prepared according to the general procedure starting from 2,6-dimethyloct-7-en-2-yl acetate (150 mg, 756 μmol) and Rh₂(TPA)₄ (10.3 mg, 8.0 μmol) in dichloromethane (3.8 mL) and ethyl diazoacetate (248 mg, 1.89 mmol, 2.5 equiv.) in dichloromethane (4.7 mL). The crude product was purified by column chromatography (n-pentane/Et₂O, 10:1) to obtain the title compound (163 mg, 573 μmol, 76%) as a light-yellow oil. The compound needs additional purification and is not stable under the conditions employed in GC-MS measurements.

d.r.=2.1:8:1

R_{f}=0.3, 0.36 (n-pentane/Et₂O, 10:1).

GC-MS (5% methyl phenyl siloxane, 30 m, 0.25 μm, He): t_{R1}=9.751 min (18.6%, [M]⁺ 181.1), t_{R2}=9.986 min (72.4%, [M]⁺ 181.1), t_{R3}=10.061 min (9%, [M]⁺=181.1).

¹H NMR (400 MHz, CDCl₃, ppm) δ=4.17-4.06 (m, 2H, C15-CH₂), 1.95 (s, 3H, C1-CH₃), 1.72-1.32 (m, 12H, C3-CH₃, C5-CH₃, C6-CH₂, C7-CH₂, C10-CH, H_{Cpr}), 1.27-1.22 (m, 4H, H_{Cpr}, C16-CH₃), 1.17-0.63 (m, 7H, C8-CH₂, C9-CH₃, 2×H_{Cpr}).

¹³C NMR (101 MHz, CDCl₃, ppm) δ=174.83, 174.61, 173.40, 173.34, 170.64, 170.59, 82.56, 82.51, 61.38, 60.45, 60.39 (C15), 41.19, 41.01, 37.86, 37.76, 37.39, 37.19, 37.14, 31.53, 31.04, 29.82, 29.68, 29.37, 29.31, 26.21, 26.16, 26.10, 22.61 (C1), 22.47, 21.62, 21.55, 21.39, 21.32, 20.42, 20.36, 20.30, 19.66, 19.55, 19.19, 19.00, 17.72, 15.58, 14.49, 14.41, 14.24, 14.19, 14.15, 13.88, 13.78, 12.50.

IR (ATR, cm⁻¹) \tilde{v}=2976 (w), 2955 (w), 2935 (w), 2907 (w), 2871 (w), 2850 (vw), 1723 (vs), 1602 (w), 1575 (w), 1558 (w), 1545 (w), 1513 (w), 1459 (w), 1446 (w), 1405 (w), 1367 (s), 1258 (vs), 1203 (s), 1173 (vs), 1160 (vs), 1115 (m), 1095 (m), 1082 (m), 1037 (s), 1018 (s), 982 (m), 943 (m), 928 (m), 858 (m), 832 (m), 775 (w), 764 (w), 745 (w), 728 (w), 700 (w), 683 (w), 673 (w), 666 (w), 659 (w), 652 (w), 642 (w), 633 (w), 611 (w), 569 (w), 552 (w), 537 (w), 530 (w), 516 (w), 504 (w), 484 (w), 467 (w), 432 (w), 419 (w), 411 (w), 399 (w), 382 (w), 377 (w).

HRMS (ESI⁺, [M+Na]⁺, C₁₆H₂₈O₄Na) calcd: 307.1885. found: 307.1878.

### Ethyl 2-(3-acetoxy-3,5-dimethylhex-4-en-1-yl)cyclopropane-1-carboxylate (Compound (21))

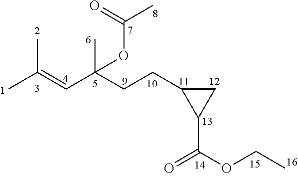 [SMILES: CCOC(=O)C1CC1CCC(C)(C=C(C)C)OC(C)=O]

The title compound was prepared according to the general procedure starting from 2,4-dimethylocta-2,7-dien-4-yl acetate (170 mg, 866 μmol) and Rh₂(TPA)₄ (11.7 mg, 9.0 μmol) in dichloromethane (4.3 mL) and ethyl diazoacetate (227 mg, 1.73 mmol, 2.0 equiv.) in dichloromethane (4.3 mL). The crude product was purified by column chromatography (n-pentane/Et₂O, 10:1) to obtain the title compound (118 mg, 420 μmol, 48%). as a light-yellow oil. The compound needs additional purification.

d.r.=1:1.3:2.5

R_{f}=0.34, 0.42 (n-pentane/Et₂O, 10:1).

GC-MS (5% methyl phenyl siloxane, 30 m, 0.25 μm, He): t_{R1}=9.959 min (20.9%, [M-C₂H₄O₂]⁺ 222.2), t_{R2}=10.064 min (27.9%, [M-C₂H₄O₂]⁺ 222.2), t_{R3}=10.146 min (51.2%, [M-C₂H₄O₂]⁺ 222.2).

¹H NMR (400 MHz, CDCl₃, ppm) δ=4.20-4.09 (m, 2H, C15-CH₂), 1.39-1.34 (m, 1H, H_{Cpr}), 1.32-1.25 (m, 3H, C16-CH₃), 0.76-0.68 (m, 1H, H_{Cpr}).

¹³C NMR (101 MHz, CDCl₃, ppm) δ=173.19, 145.68, 142.39, 142.28, 137.34, 136.97, 128.24, 127.43, 127.28, 126.06, 125.94, 125.81, 125.70, 124.50, 114.07, 113.93, 113.51, 112.99, 112.87, 77.48, 77.16, 76.84, 60.46, 60.41 (C15), 40.86, 40.31, 37.75, 37.35, 32.69, 32.19, 32.11, 31.75, 31.00, 27.07, 26.84, 26.76, 26.10, 25.84, 25.72, 24.25, 23.94, 23.90, 23.84, 22.74, 22.67, 22.01, 21.78, 21.65, 21.57, 20.36, 20.31, 19.99, 19.71, 19.65, 18.44, 18.33, 17.97, 17.92, 17.26, 15.57 (C_{Cpr}), 15.23, 14.52, 14.42, 13.52, 13.48, 13.36.

IR (ATR, cm⁻¹) \tilde{v}=2979 (w), 2932 (w), 2873 (w), 1721 (vs), 1618 (w), 1543 (vw), 1533 (vw), 1524 (vw), 1517 (vw), 1506 (vw), 1446 (m), 1407 (m), 1378 (s), 1357 (m), 1332 (w), 1300 (w), 1266 (m), 1173 (vs), 1164 (vs), 1094 (s), 1079 (s), 1041 (s), 994 (s), 908 (m), 890 (m), 858 (m), 830 (s), 730 (w), 680 (w), 671 (w), 663 (w), 636 (w), 626 (w), 603 (m), 582 (m), 555 (m), 547 (m), 535 (m), 521 (m), 506 (m), 482 (m), 466 (m), 453 (m), 446 (m), 439 (m), 426 (m), 416 (m), 411 (m), 399 (m), 392 (m), 382 (m).

### Ethyl 2-(cyclohex-3-en-1-yl)cyclopropane-1-carboxylate (Compound (8))

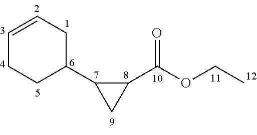

The title compound was prepared according to the general procedure starting from 4-vinyl-1-cyclohexene (150 mg, 1.39 mmol) and Rh₂(TPA)₄ (18.8 mg, 14.0 μmol) in dichloromethane (6.9 mL) and ethyl diazoacetate (316 mg, 2.77 mmol, 2.0 equiv.) in dichloromethane (6.9 mL). The crude product was purified by column chromatography (n-pentane/Et₂O, 30:1) to obtain the title compound (124 mg, 637 μmol, 46%) as a colorless oil.

d.r.=1:1.5

R_{f}=0.46, 0.55 (n-pentane/Et₂O, 30:1).

GC-MS (5% methyl phenyl siloxane, 30 m, 0.25 μm, He): t_{R1}=9.340 min (40%, [M]⁺ 194.1), t_{R2}=9.628 min (60%, [M]⁺ 194.1).

¹H NMR (400 MHz, CDCl₃, ppm) δ=5.68-5.58 (m, 1H, CH═CH), 5.01-4.85 (m, 1H, CH═CH), 4.18-4.05 (m, 2H, C11-CH₂), 2.22-1.70 (m, 4H, C1-CH₂, C4-CH₂), 1.63-0.72 (m, 10H, C5-CH₂, C6-CH, C7-CH, C8-CH, C9-CH₂, C12-CH₃).

¹³C NMR (101 MHz, CDCl₃, ppm) δ=174.73, 174.69, 173.28, 173.23 (C10), 144.93, 144.25, 143.61, 143.41, 127.16, 127.08 (C2), 126.36, 126.17, 126.12, 112.91, 112.67, 112.40 (C3), 60.46, 60.40, 60.00 (C11), 38.17, 37.88, 37.75, 37.71, 36.17, 35.61, 31.90, 31.85, 31.68, 31.28, 31.08, 29.53, 28.88, 28.79, 28.63, 28.58, 28.40, 28.22, 28.16, 28.09, 28.00, 27.56, 26.97, 26.30, 26.06, 25.91, 25.35, 25.07, 24.96, 24.81, 24.48, 23.32, 22.87, 22.80, 22.52, 22.42, 21.24, 21.16, 19.49, 19.22, 19.07, 18.17, 18.07, 17.10, 16.57, 15.60, 14.56, 14.52, 14.46, 14.41, 14.21, 12.70, 12.58.

IR (ATR, cm⁻¹) \tilde{v}=3021 (vw), 2979 (w), 2924 (w), 2874 (w), 2856 (w), 2839 (vw), 1721 (vs), 1639 (w), 1476 (w), 1446 (w), 1411 (w), 1378 (w), 1373 (w), 1354 (w), 1339 (w), 1327 (w), 1309 (w), 1265 (w), 1249 (w), 1221 (w), 1171 (vs), 1164 (vs), 1095 (m), 1041 (m), 993 (m), 949 (w), 911 (m), 861 (m), 839 (w), 800 (w), 790 (w), 756 (w), 722 (m), 711 (w), 683 (w), 653 (s), 601 (w), 591 (w), 578 (w), 568 (w), 562 (w), 543 (w), 537 (w), 527 (w), 511 (w), 497 (w), 472 (w), 459 (w), 446 (w), 435 (w), 425 (w), 419 (w), 411 (w), 397 (w), 382 (w).

HRMS (ESI⁺, [M+H]⁺, C₁₂H₁₉O₂⁺) calc: 195.1380. found: 195.1378.

### Ethyl bicyclo[4.1.0]heptane-7-carboxylate (Compound (9))

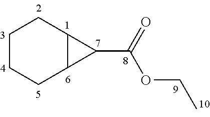

The title compound was prepared according to the general procedure starting from cyclohexene (150 mg, 1.83 mmol) and Rh₂(TPA)₄ (24.8 mg, 18.0 μmol) in dichloromethane (9.1 mL) and ethyl diazoacetate (719 mg, 5.48 mmol, 3.0 equiv.) in dichloromethane (13.7 mL). The crude product was purified by column chromatography (n-pentane/Et₂O, 30:1) to obtain the title compound (162 mg, 1.14 mmol, 62%) as a colorless oil.

d.r.=1:1.5

R_{f}=0.34, 0.57 (n-pentane/Et₂O, 30:1).

GC-MS (5% methyl phenyl siloxane, 30 m, 0.25 μm, He): t_{R1}=8.178 min (40%, [M]⁺ 168.1), t_{R2}=8.418 min (60%, [M]⁺ 168.1).

¹H NMR (400 MHz, CDCl₃, ppm) δ=4.16-4.04 (m, 2H, C9-CH₂), 1.94-1.79 (m, 2H, C1-CH, C6-CH), 1.74-1.63 (m, 2H, 2×CH_{Cy}), 1.60-1.50 (m, 2H, 2×CH_{Cy}), 1.37 (t, J=4.3 Hz, 1H, C7-CH), 1.33-1.10 (m, 7H, including 1.25 (t, J=7.2 Hz, 3H), 6×CH_{Cy}).

¹³C NMR (101 MHz, CDCl₃, ppm) δ=175.05, 172.12 (C8), 62.42, 61.46, 60.32 (C9), 59.92, 26.41, 25.83, 22.87 (C6), 22.27, 22.21, 21.36, 21.09, 18.69 (C1), 16.47 (C7), 14.55, 14.45 (C10), 14.24.

IR (ATR, cm⁻¹) \tilde{v}=2980 (w), 2929 (m), 2857 (w), 1720 (vs), 1647 (w), 1618 (w), 1578 (vw), 1571 (vw), 1553 (vw), 1545 (vw), 1462 (w), 1446 (m), 1425 (m), 1390 (w), 1377 (w), 1367 (m), 1347 (w), 1303 (vs), 1262 (m), 1210 (w), 1184 (vs), 1166 (vs), 1150 (vs), 1116 (m), 1095 (s), 1047 (s), 1020 (m), 982 (m), 956 (m), 945 (m), 867 (w), 853 (w), 836 (m), 820 (w), 812 (w), 793 (w), 779 (s), 730 (w), 703 (m), 670 (w), 653 (w), 632 (w), 611 (w), 601 (w), 588 (w), 571 (w), 555 (w), 541 (w), 521 (w), 499 (w), 490 (w), 469 (w), 450 (w), 438 (w), 424 (w), 411 (w), 378 (m).

HRMS (ESI⁺, [M+H]⁺, C₁₀H₁₇O₂⁺) calcd: 169.1223. found: 169.1220.

The analytical data match with those reported in the literature. (Keigo, Toshihiro, & Noritaka, 2010)

### Ethyl 3-methylbicyclo[4.1.0]heptane-7-carboxylate (Compound (10))

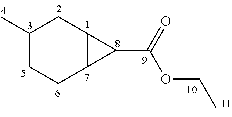

The title compound was prepared according to the general procedure starting from 4-methyl-1-cyclohexene (150 mg, 1.56 mmol) and Rh₂(TPA)₄ (21.1 mg, 16.0 μmol) in dichloromethane (7.8 mL) and ethyl diazoacetate (573 mg, 4.38 mmol, 2.8 equiv.) in dichloromethane (10.9 mL). The crude product was purified by column chromatography (n-pentane/Et₂O, 30:1) to obtain the title compound (261 mg, 1.43 mmol, 92%) as a colorless oil.

d.r.=1:2.3 (30.1:69.9)

R_{f}=0.39, 0.64 (n-pentane/Et₂O, 30:1).

GC-MS (5% methyl phenyl siloxane, 30 m, 0.25 μm, He): t_{R1}=8.528 min (30.1%, [M]⁺ 182.1), t_{R2}=8.831 min (69.9%, [M]⁺ 182.1).

¹H NMR (400 MHz, CDCl₃, ppm) δ=4.16-4.03 (m, 2H, C10-CH₂), 2.14-0.76 (m, 16H including 1.24, t, J=7.0 Hz, 3H, C11-CH₃).

¹³C NMR (101 MHz, CDCl₃, ppm) δ=174.98, 172.11 (C9), 62.41, 61.45, 60.32 (C10), 59.91, 32.21, 31.55, 30.63, 29.46, 28.88, 28.81, 28.59, 28.18, 26.95, 26.60, 26.36, 26.29, 25.93, 23.99, 23.31, 22.94, 22.68, 22.57, 22.51, 22.47, 22.38, 22.27, 22.13, 21.97, 21.27, 19.94, 18.44, 18.29, 16.95, 15.59, 14.55, 14.45, 14.24, 14.20.

IR (ATR, cm⁻¹) \tilde{v}=2980 (w), 2951 (w), 2924 (w), 2868 (w), 2854 (w), 1721 (vs), 1647 (vw), 1458 (m), 1445 (m), 1428 (m), 1367 (w), 1343 (w), 1330 (w), 1312 (s), 1296 (m), 1261 (m), 1230 (w), 1211 (w), 1171 (vs), 1150 (vs), 1095 (m), 1048 (s), 1006 (m), 992 (m), 977 (m), 955 (w), 918 (w), 907 (w), 897 (w), 888 (w), 861 (w), 826 (w), 806 (m), 799 (m), 772 (w), 731 (w), 707 (m), 666 (w), 654 (w), 623 (w), 609 (w), 594 (w), 584 (w), 572 (w), 552 (w), 544 (w), 526 (w), 518 (w), 503 (w), 490 (w), 472 (w), 449 (w), 438 (w), 424 (w), 411 (w), 404 (w), 391 (w), 375 (w). 30

HRMS (ESI⁺, [M+H]⁺, C₁₁H₁₉O₂⁺) calcd: 183.1380. found: 183.1377.

### Ethyl 2-(cyclohexylmethyl)cyclopropane-1-carboxylate (Compound (30))

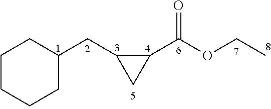

The title compound was prepared according to the general procedure starting from allylcyclohexane (150 mg, 1.21 mmol) and Rh₂(TPA)₄ (16.4 mg, 12.0 μmol) in dichloromethane (6.0 mL) and ethyl diazoacetate (396 mg, 3.02 mmol, 2.5 equiv.) in dichloromethane (7.6 mL). The crude product was purified by column chromatography (n-pentane/Et₂O, 30:1) to obtain the title compound (209 mg, 992 μmol, 82%) as a colorless oil.

d.r.=1:3.2

R_{f}=0.4, 0.49 (n-pentane/Et₂O, 30:1)

GC-MS (5% methyl phenyl siloxane, 30 m, 0.25 μm, He): t_{R1}=9.907 min (24%, [M]⁺ 211.2), t_{R2}=9.961 min (76%, [M]⁺ 211.2).

¹H NMR (400 MHz, CDCl₃, ppm) δ=4.15-4.07 (m, 2H, C7-CH₂), 1.65-1.59 (m, 2H, C2-CH₂), 1.44-0.88 (m, 17H, including 1.31 (dt, J=8.4, 4.4 Hz, 1H, C4-CH), 1.28-1.22 (m, 3H, C8-CH₃), 1.03-0.94 (m, 1H, C1-CH), 2×H_{Cpr}, 5×H_{Cy}), 0.65 (ddd, J=8.2, 6.4, 4.0 Hz, 1H, H_{Cpr}).

¹³C NMR (101 MHz, CDCl₃, ppm) δ=174.80, 173.27 (C6), 60.40, 60.31 (C7), 41.11, 38.44, 38.18, 34.55, 33.42, 33.34, 33.25, 26.76, 26.71, 26.55, 26.52, 26.44, 21.12, 20.56, 20.14, 18.40, 15.87 (C_{Cpr}), 14.52, 14.44, 13.53.

IR (ATR, cm⁻¹) \tilde{v}=3000 (vw), 2980 (w), 2921 (s), 2850 (m), 1724 (vs), 1656 (w), 1649 (w), 1598 (w), 1578 (vw), 1561 (vw), 1541 (w), 1536 (w), 1528 (vw), 1516 (vw), 1509 (vw), 1448 (s), 1407 (m), 1380 (m), 1370 (m), 1341 (w), 1322 (w), 1307 (w), 1264 (m), 1203 (m), 1163 (vs), 1113 (m), 1095 (m), 1081 (m), 1062 (m), 1037 (s), 990 (m), 963 (w), 948 (m), 914 (w), 891 (w), 875 (m), 860 (m), 844 (m), 829 (m), 806 (w), 765 (w), 737 (w), 694 (w), 679 (w), 669 (w), 643 (w), 635 (w), 619 (w), 609 (w), 598 (w), 585 (w), 564 (w), 552 (w), 545 (w), 537 (w), 521 (w), 511 (w), 493 (w), 473 (w), 462 (w), 446 (w), 441 (w), 418 (w), 409 (w), 404 (w), 394 (w), 388 (w), 384 (w).

HRMS (ESI⁺, [M+H]⁺, C₁₃H₂₃O₂⁺) calcd: 211.1693. found: 211.1689.

### Ethyl 2-(cyclopentylmethyl)cyclopropane-1-carboxylate (Compound (34))

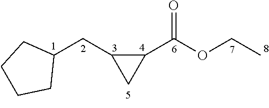

The title compound was prepared according to the general procedure starting from allylcyclopentane (150 mg, 1.36 mmol) and Rh₂(TPA)₄ (18.5 mg, 14.0 μmol) in dichloromethane (6.8 mL) and ethyl diazoacetate (446 mg, 3.40 mmol, 2.5 equiv.) in dichloromethane (8.5 mL). The crude product was purified by column chromatography (n-pentane/Et₂O, 30:1) to obtain the title compound (218 mg, 1.11 mmol, 82%) as a colorless oil.

d.r.=1:1.5

R_{f}=0.34, 0.43 (n-pentane/Et₂O, 30:1).

GC-MS (5% methyl phenyl siloxane, 30 m, 0.25 μm, He): t_{R1}=9.242 min (40%, [M]⁺ 197.2), t_{R2}=9.320 min (60%, [M]⁺ 197.2).

¹H NMR (400 MHz, CDCl₃, ppm) δ=4.11 (qd, J=7.1, 5.5 Hz, 2H, C7-CH₂), 1.90-0.88 (m, 17H, including 1.36-1.31 (m, 1H, H_{Cpr}), 1.24 (td, J=7.2, 2.3 Hz, 3H, C8-CH₃), 1.16-1.04 (m, 1H, H_{Cpr}), C1-CH, 4×CH_{2 Cp}), 0.72-0.63 (m, 1H, H_{Cpr}).

¹³C NMR (101 MHz, CDCl₃, ppm) δ=174.76, 173.27 (C6), 60.39, 60.31 (C7), 40.71, 40.44, 39.70, 39.40 (C8), 32.98, 32.73, 32.67 (C_{Cpr}), 32.61 (C_{Cpr}), 32.55, 31.57, 25.19, 25.14, 22.47, 21.38, 20.45 (C_{Cpr}), 18.38, 15.71 (C_{Cpr}), 14.50, 14.42, 13.49.

IR (ATR, cm⁻¹) \tilde{v}=2976 (w), 2948 (m), 2908 (w), 2867 (w), 1724 (vs), 1656 (vw), 1618 (vw), 1448 (w), 1405 (m), 1380 (m), 1370 (w), 1354 (w), 1340 (w), 1315 (w), 1303 (w), 1264 (w), 1160 (vs), 1115 (m), 1095 (m), 1081 (m), 1038 (m), 993 (w), 963 (w), 926 (w), 875 (w), 858 (m), 829 (m), 812 (w), 806 (w), 796 (w), 737 (w), 670 (w), 643 (w), 630 (w), 619 (w), 598 (w), 581 (w), 568 (w), 561 (w), 550 (w), 538 (w), 527 (w), 514 (w), 503 (w), 484 (w), 479 (w), 459 (w), 445 (w), 426 (w), 414 (w), 404 (w), 392 (w), 378 (w).

HRMS (ESI⁺, [M+H]⁺, C₁₂H₂₁O₂⁺) calcd.: 197.1536. found: 197.1534.

### Ethyl 2-methyl-3-((2,2,3-trimethylcyclopentyl)methyl)cyclopropane-1-carboxylate (Compound 35))

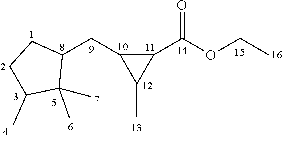 [SMILES: CCOC(=O)C1C(C)C1CC1CCC(C)C1(C)C]

The title compound was prepared according to the general procedure starting from (E)-2-(but-2-en-1-yl)-1,1,5-trimethylcyclopentane (150 mg, 0.90 mmol) and Rh₂(TPA)₄ (12.2 mg, 9.02 μmol) in dichloromethane (4.5 mL) and ethyl diazoacetate (355 mg, 2.71 mmol, 3 equiv.) in dichloromethane (6.8 mL). The crude product was purified by column chromatography (n-pentane/Et₂O, 30:1) to obtain the title compound (172 mg, 0.68 mmol, 76%) as a colorless oil.

d.r.=1:2.3

R_{f}=0.49, 0.54 (n-pentane/Et₂O, 30:1).

GC-MS (5% methyl phenyl siloxane, 30 m, 0.25 μm, He): t_{R1}=10.905 min (70%, [M]⁺ 252.2), t_{R2}=11.035 min (30%, [M]⁺ 252.2).

¹H NMR (400 MHz, CDCl₃, ppm) δ=4.10 (q, J=7.1, 2H), 1.95-0.71 (m, 26H, including 1.25 (t, J=7.1 Hz, 3H, C16-CH₃), 0.89-0.72 (m, 9H, C4-CH₃, C6-CH₃, C7-CH₃).

¹³C NMR (101 MHz, CDCl₃, ppm) δ=174.86 (C14), 60.33 (C16), 51.23, 51.10, 45.25, 45.15, 42.56, 42.38, 30.30, 30.19, 28.36, 28.29, 28.21, 27.83, 27.50, 25.73, 22.67, 21.48, 14.56, 14.48, 14.37, 14.05, 12.61, 12.00.

### Ethyl 2-methyl-3-((2,2,3-trimethylcyclopent-3-en-1-yl)methyl)cyclopropane-1-carboxylate (Compound (36))

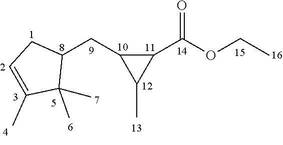 [SMILES: CCOC(=O)C1C(C)C1CC1CC=C(C)C1(C)C]

The title compound was prepared according to the general procedure starting from (E)-4-(but-2-en-1-yl)-1,1,5-trimethylcyclopent-1-ene (150 mg, 0.91 mmol) and Rh₂(TPA)₄ (12.4 mg, 9.10 μmol) in dichloromethane (4.6 mL) and ethyl diazoacetate (240 mg, 1.83 mmol, 2 equiv.) in dichloromethane (4.6 mL). The crude product was purified by column chromatography (n-pentane/Et₂O, 30:1) to obtain the title compound (151 mg, 0.60 mmol, 66%) as a colorless oil.

d.r.=1:5.5:1.1:18.3:12.5

R_{f}=0.48, 0.53, 0.61 (n-pentane/Et₂O, 30:1).

GC-MS (5% methyl phenyl siloxane, 30 m, 0.25 μm, He): t_{R1}=10.460 min (2.6%, [M-CH₃]⁺ 235.2), t_{R2}=10.565 min (14.4%, [M-CH₃]⁺ 235.2), t_{R3}=10.669 min (2.9%, [M-CH₃]⁺ 235.2), t_{R4}=10.792 min (47.6%, [M]⁺ 250.1), t_{R5}=10.910 min (32.5%, [M]⁺ 250.1).

¹H NMR (400 MHz, CDCl₃, ppm) δ=5.46-5.26 (m, 1H, C2-CH), 4.17-4.03 (m, 2H, C15-CH₂), 2.41-0.69 (m, 23H, including 1.58 (s, 3H, C4-CH₃), 1.28-1.22 (m, 3H, C16-CH₃).

¹³C NMR (101 MHz, CDCl₃, ppm) δ=174.82, 174.78, 173.29, 172.42, 172.35, 172.13 (C14), 149.09, 148.97, 148.80, 148.68 (C2/C3), 130.97, 130.11, 129.89 (C2/C3), 124.16, 123.91, 121.98, 121.85, 121.73, 60.41, 60.35, 60.19, 59.78 (C15), 51.03, 50.77, 50.67, 50.61, 47.07, 46.96, 46.80, 45.19, 44.96, 44.64, 43.49, 43.08, 42.60, 39.87, 35.71, 35.67, 35.64, 35.26, 33.91, 32.34, 31.75, 31.59, 31.28, 28.24, 27.94, 27.79, 27.65, 27.55, 27.30, 27.01, 26.77, 26.68, 25.89, 25.84, 25.81, 25.76, 24.52, 24.27, 23.06, 22.57, 22.22, 21.99, 21.95, 21.42, 21.34, 21.28, 20.91, 20.45, 20.21, 20.08, 19.75, 19.63, 19.39, 19.22, 18.71, 18.01, 14.55, 14.49, 14.46, 14.37, 14.26, 12.92, 12.75, 12.57, 11.97, 9.83, 7.84, 7.36.

IR (ATR, cm⁻¹) \tilde{v}=3010 (vw), 2955 (m), 2931 (m), 2867 (w), 1723 (vs), 1655 (w), 1639 (w), 1630 (w), 1619 (w), 1602 (w), 1579 (w), 1571 (w), 1561 (w), 1544 (w), 1534 (w), 1524 (W), 1509 (w), 1460 (m), 1443 (m), 1417 (w), 1402 (w), 1381 (m), 1363 (m), 1319 (m), 1299 (w), 1282 (w), 1261 (w), 1235 (w), 1220 (m), 1173 (vs), 1153 (vs), 1118 (m), 1095 (s), 1075 (m), 1044 (s), 1013 (m), 986 (w), 963 (m), 919 (w), 891 (w), 860 (w), 849 (w), 826 (w), 798 (m), 776 (w), 713 (m), 701 (w), 654 (w), 637 (w), 620 (w), 613 (w), 598 (w), 582 (w), 538 (w), 517 (w), 507 (w), 500 (w), 487 (w), 473 (w), 465 (w), 448 (w), 432 (w), 398 (w), 380 (w) cm⁻¹.

HRMS (ESI⁺, [M+H]⁺, C₁₆H₂₇O₂⁺) calcd.: 251.2006, found: 251.2001.

### Methyl 2-cyclohexylcyclopropane-1-carboxylate (Compound (12))

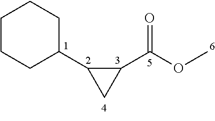

The title compound was prepared according to the general procedure starting from vinylcyclohexane (150 mg, 1.36 mmol) and Rh₂(TPA)₄ (18.5 mg, 14.0 μmol) in dichloromethane (6.8 mL) and methyl diazoacetate (511 mg, 4.08 mmol, 3.0 equiv.) in dichloromethane (10.2 mL). The crude product was purified by column chromatography (n-pentane/Et₂O, 30:1) to obtain the title compound (204 mg, 1.12 mmol, 82%) as a colorless oil.

d.r.=1:1.1

R_{f}=0.31, 0.43 (n-pentane/Et₂O, 30:1).

GC-MS (5% methyl phenyl siloxane, 30 m, 0.25 μm, He): t_{R1}=8.528 min (47%, [M]⁺ 182.1), t_{R2}=8.840 min (53%, [M]⁺ 182.1).

¹H NMR (400 MHz, CDCl₃, ppm) δ=3.65 (s, 3H, C6-CH₃), 1.81-1.54 (m, 5H, 5×CH_{Cy}), 1.41-1.33 (m, 1H, C3-CH), 1.26-0.99 (m, 7H, 5×CH_{Cy}, C1-CH, CH_{Cpr}), 0.99-0.91 (m, 1H, CH_{Cpr}), 0.75-0.62 (m, 2H, CH_{Cpr}).

¹³C NMR (101 MHz, CDCl₃, ppm) δ=175.27 (C5), 173.87 (C5), 51.71 (C6), 51.65 (C6), 37.39, 35.88, 33.41, 33.34, 33.24, 32.75, 32.57, 29.57 (C_{Cpr}), 28.82, 26.57, 26.50, 26.23, 26.18, 26.08, 18.86 (C_{Cpr}), 17.78 (C_{Cpr}), 15.40 (C_{Cpr}), 14.39 (C_{Cpr}).

IR (ATR, cm⁻¹) \tilde{v}=3003 (vw), 2922 (s), 2850 (m), 1727 (vs), 1657 (w), 1599 (w), 1578 (w), 1571 (w), 1550 (w), 1527 (w), 1510 (w), 1446 (s), 1436 (s), 1401 (w), 1381 (m), 1367 (m), 1336 (m), 1322 (w), 1299 (w), 1278 (m), 1265 (m), 1238 (w), 1193 (vs), 1160 (vs), 1118 (m), 1099 (m), 1082 (m), 1077 (m), 1043 (m), 1031 (m), 992 (m), 933 (m), 909 (w), 887 (s), 873 (m), 843 (m), 824 (m), 782 (w), 773 (w), 747 (w), 711 (w), 684 (w), 666 (w), 637 (w), 630 (w), 622 (w), 603 (w), 592 (w), 586 (w), 568 (w), 554 (w), 535 (w), 516 (w), 507 (w), 492 (w), 482 (w), 470 (w), 455 (w), 442 (w), 426 (w), 415 (w), 399 (w), 390 (w), 375 (w).

HRMS (ESI⁺, [M+H]⁺, C₁₁H₁₉O₂⁺) calcd: 183.1380. found: 183.1377.

### Methyl 1-methylbicyclo[3.1.0]hexane-6-carboxylate (Compound (11))

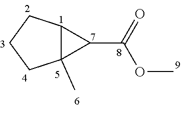

The title compound was prepared according to the general procedure starting from 1-methylcyclopentene (100 mg, 1.22 mmol) and Rh₂(TPA)₄ (16.5 mg, 12.0 μmol) in dichloromethane (6.1 mL) and methyl diazoacetate (457 mg, 3.65 mmol, 3.0 equiv.) in dichloromethane (9.1 mL). The crude product was purified by column chromatography (n-pentane/Et₂O, 30:1) to obtain the title compound (182.2 mg, 1.182 mmol, 97%) as a colorless oil.

d.r.=1:1.2

R_{f}=0.31, 0.40 (n-pentane/Et₂O, 30:1).

GC-MS (5% methyl phenyl siloxane, 30 m, 0.25 μm, He): t_{R1}=6.514 min (45%, [M]⁺ 154.1), t_{R2}=6.806 min (55%, [M]⁺ 154.1).

¹H NMR (400 MHz, CDCl₃, ppm) δ=3.64 (s, 3H, C9-CH₃), 2.01-1.52 (m, 6H, 3×H_{Cp}), 1.50 (d, J=3.5 Hz, 1H, C7-CH), 1.45-1.25 (m, 4H, C6-CH₃, C1-CH).

¹³C NMR (101 MHz, CDCl₃, ppm) δ=173.49, 172.28 (C8), 51.54, 51.43, 50.92 (C9), 35.54, 35.33, 33.86 (C_{Cp}), 33.38, 33.06, 32.53, 32.27, 30.29, 28.03, 26.61, 25.92 (C_{Cpr}), 24.50, 22.68, 20.99, 15.10 (C_{Cpr}).

IR (ATR, cm⁻¹) \tilde{v}=3014 (vw), 2929 (m), 2856 (w), 1723 (vs), 1655 (w), 1649 (w), 1619 (w), 1579 (w), 1560 (w), 1554 (w), 1543 (vw), 1534 (vw), 1527 (vw), 1509 (vw), 1438 (vs), 1378 (w), 1349 (w), 1306 (vs), 1283 (w), 1265 (m), 1193 (vs), 1183 (s), 1166 (vs), 1152 (vs), 1081 (m), 1048 (m), 1018 (m), 960 (s), 950 (m), 916 (m), 866 (w), 851 (w), 839 (w), 815 (w), 793 (w), 779 (s), 715 (m), 704 (m), 654 (w), 633 (w), 592 (w), 577 (w), 568 (w), 547 (w), 534 (w), 518 (w), 504 (w), 489 (w), 460 (w), 432 (w), 415 (w), 407 (w), 399 (w), 378 (w).

HRMS (ESI⁺, [M+H]⁺, C₉H₁₅O₂⁺) calcd: 155.1067. found: 155.1063.

### Methyl 2-(3,5-dimethylhexyl-4-en-1-yl)cyclopropane-1-carboxylate (Compound (19))

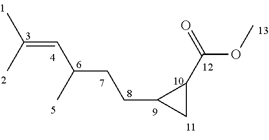

The title compound was prepared according to the general procedure starting from 5,7-dimethylocta-1,6-diene (150 mg, 1.09 mmol) and Rh₂(TPA)₄ (14.7 mg, 11.0 μmol) in dichloromethane (5.4 mL) and methyl diazoacetate (339 mg, 2.71 mmol, 2.5 equiv.) in dichloromethane (6.8 mL). The crude product was purified by column chromatography (n-pentane/Et₂O, 30:1) to obtain the title compound (142 mg, 675 μmol, 62%) as a colorless oil.

d.r.=1:1.2

R_{f}=0.45, 0.55 (n-pentane/Et₂O, 30:1).

GC-MS (5% methyl phenyl siloxane, 30 m, 0.25 μm, He): t_{R1}=9.103 min (47%, [M]⁺ 210.2), t_{R2}=9.254 min (53%, [M]⁺ 210.2).

¹H NMR (400 MHz, CDCl₃, ppm) δ=4.91-4.79 (m, 1H, C4-CH), 3.66 (s, 3H, C13-CH₃), 2.38-2.23 (m, 1H, C6-CH), 1.66 (s, 3H. C1-CH₃), 1.58 (s, 3H, C2-CH₃), 1.47-0.92 (m, 7H, C7-CH₂, C8-CH2, 3×H_{Cpr}), 0.90-0.86 (m, 3H, C5-CH₃), 0.71-0.64 (m, 1H, H_{Cpr}).

¹³C NMR (101 MHz, CDCl₃, ppm) δ=173.65, 173.58 (C12), 131.51, 131.45 (C3), 131.24, 131.21 (C4), 130.23, 130.02, 129.97, 51.71, 51.59 (C13), 37.79, 37.40, 37.22, 32.44 (C6), 32.35, 32.26, 32.22, 31.13, 25.90, 25.18, 25.15 (C2), 23.33, 22.26, 22.20, 21.43, 21.26, 20.17, 20.08, 18.20, 18.16, 18.05 (C1), 15.81, 15.69 (C_{Cpr}), 13.67, 13.59 (C5).

IR (ATR, cm⁻¹) \tilde{v}=3003 (vw), 2952 (w), 2919 (w), 2866 (w), 2854 (w), 1730 (vs), 1677 (w), 1656 (vw), 1649 (vw), 1629 (vw), 1619 (vw), 1528 (vw), 1516 (vw), 1509 (vw), 1436 (s), 1401 (w), 1378 (m), 1353 (w), 1334 (w), 1317 (w), 1302 (w), 1268 (w), 1194 (vs), 1166 (vs), 1132 (m), 1084 (m), 1069 (w), 1045 (m), 977 (w), 967 (w), 946 (w), 918 (w), 898 (w), 866 (w), 843 (m), 823 (m), 776 (w), 758 (w), 728 (w), 683 (w), 666 (w), 626 (w), 615 (w), 602 (w), 591 (w), 581 (w), 571 (w), 557 (w), 547 (w), 540 (w), 530 (w), 514 (w), 497 (w), 483 (w), 475 (w), 465 (w), 455 (w), 448 (w), 433 (w), 419 (w), 411 (w), 398 (w), 385 (w).

HRMS (ESI⁺, [M+H]⁺, C₁₃H₂₃O₂⁺) calcd: 211.1693. found: 211.1689.

### Methyl 2-(6-methylhept-5-en-2-yl)cyclopropane-1-carboxylate (Compound (20))

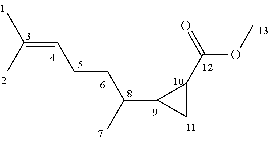

The title compound was prepared according to the general procedure starting from 3,7-dimethylocta-1,6-diene (Dihydromycene, 150 mg, 1.09 mmol) and Rh₂(TPA)₄ (14.7 mg, 11.0 μmol) in dichloromethane (5.4 mL) and methyl diazoacetate (272 mg, 2.17 mmol, 2.0 equiv.) in dichloromethane (5.4 mL). The crude product was purified by column chromatography (n-pentane/Et₂O, 30:1) to obtain the title compound (67 mg, 319 μmol, 29%) as a colorless oil.

R_{f}=0.36, 0.49 (n-pentane/Et₂O, 30:1)

GC-MS (5% methyl phenyl siloxane, 30 m, 0.25 μm, He): t_{R1}=9.637 min ([M]⁺ 210.1).

¹H NMR (400 MHz, CDCl₃, ppm) δ=5.13-4.88 (m, 1H, C4-CH), 3.70-3.61 (m, 3H, C13-CH₃), 2.14-1.88 (m, 2H, C5-CH₂), 1.67 (s, 3H, C1/C2-CH₃), 1.58 (s, 3H, C1/C2-CH₃), 1.51-0.66 (m, 10H, C6-CH₂, C8-CH, C7-CH₃, 4×H_{Cpr}).

¹³C NMR (101 MHz, CDCl₃, ppm) δ=175.31, 175.11 (C12), 173.86, 124.98, 124.94, 124.70 (CH═C), 112.92, 112.78, 112.56 (CH═C), 51.76, 51.70, 51.66, 51.48, 51.11 (C13), 42.07, 37.81, 37.72, 37.62, 37.16, 37.03, 36.97, 36.90, 36.77, 36.56, 36.44, 34.24, 34.05, 32.97, 32.90, 31.55, 30.92, 29.93, 29.80, 29.32, 29.28, 28.54, 26.27, 26.23, 25.90 (C1/C2), 25.85 (C5), 25.82, 25.67, 25.42, 21.32, 21.10, 20.53, 20.38, 20.28, 20.18, 20.04, 19.64, 19.39, 19.00, 18.78, 17.79, 17.75, 17.70, 17.51 (C1/C2), 15.69, 14.37, 14.11, 13.99, 12.60.

IR (ATR, cm⁻¹) \tilde{v}=2952 (w), 2918 (w), 2871 (w), 2856 (w), 1728 (vs), 1639 (w), 1612 (vw), 1602 (vw), 1589 (vw), 1578 (vw), 1571 (vw), 1561 (vw), 1544 (vw), 1527 (vw), 1510 (vw), 1436 (s), 1398 (w), 1377 (m), 1354 (m), 1268 (w), 1193 (s), 1167 (vs), 1115 (m), 1095 (m), 1082 (m), 1045 (w), 1030 (w), 993 (w), 912 (m), 880 (w), 840 (m), 824 (m), 782 (w), 748 (w), 741 (w), 727 (w), 705 (w), 683 (w), 664 (w), 632 (w), 620 (w), 603 (w), 589 (w), 578 (w), 568 (w), 562 (w), 557 (w), 547 (w), 538 (w), 521 (w), 516 (w), 503 (w), 487 (w), 465 (w), 445 (w), 433 (w), 426 (w), 419 (w), 404 (w), 382 (w).

HRMS (ESI⁺, [M+H]⁺, C₁₃H₂₃O₂⁺) calcd: 211.1693. found: 211.1691.

### Methyl 2-(6-methylhepta-1,5-dien-2-yl)cyclopropane-1-carboxylate (Compound (29)

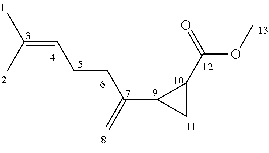

The title compound was prepared according to the general procedure starting from 7-methyl-3-methylideneocta-1,6-diene (150 mg, 1.10 mmol) and Rh₂(TPA)₄ (14.9 mg, 11.0 μmol) in dichloromethane (5.5 mL) and methyl diazoacetate (276 mg, 2.20 mmol, 2.0 equiv.) in dichloromethane (5.5 mL). The crude product was purified by column chromatography (n-pentane/Et₂O, 30:1) to obtain the title compound (97 mg, 466 μmol, 42%) as a colorless oil.

d.r.=1:1:1.8

R_{f}=0.3, 0.39, 0.49 (n-pentane/Et₂O, 30:1).

GC-MS (5% Methyl phenyl siloxane, 30 m, 0.25 μm, He): t_{R1}=9.352 min (26.6%, [M]⁺ 208.1), t_{R2}=9.577 min (25.6%, [M]⁺ 208.1), t_{R3}=9.853 min (47.8%, [M]⁺ 208.1).

¹H NMR (400 MHz, CDCl₃, ppm) δ=5.83-5.63 (m, 1H, C4-CH), 5.20-4.85 (m, 2H, C8-CH₂), 3.70-3.59 (m, 3H, C13-CH₃), 2.34-1.82 (m, 4H, C5-CH₂, C6-CH₂), 1.79-0.79 (m, 10H, C1-CH₃, C2-CH₃, 4×H_{Cpr}).

¹³C NMR (101 MHz, CDCl₃, ppm) δ=174.40, 172.48, 172.00, 171.88 (C12), 147.46, 143.54, 141.67 (C4), 138.83, 136.74 (C4), 132.06, 132.02, 131.81, 131.66, 124.14, 123.94, 123.89, 120.94, 120.68, 116.26, 115.62, 113.40, 113.21, 112.70, 108.89, 51.91, 51.85, 51.74, 51.64, 51.60, 51.49 (C13), 37.23, 37.14, 35.94, 35.58, 35.23, 33.85, 32.91, 32.80, 31.38, 31.09, 31.04, 30.99, 30.95, 29.91, 28.88, 28.44, 28.26, 28.16, 27.90, 27.48, 27.29, 27.21, 27.17, 27.04, 26.67, 26.43, 26.16, 25.90, 25.81, 25.45, 23.62, 23.58, 23.53, 21.99, 21.83, 21.38, 21.05, 20.99, 20.52, 20.49, 19.68, 17.82, 17.78, 17.70, 14.91, 11.08.

IR (ATR, cm⁻¹) \tilde{v}=2951 (w), 2924 (w), 2856 (w), 1728 (vs), 1639 (w), 1594 (w), 1578 (w), 1571 (w), 1560 (w), 1543 (w), 1534 (w), 1527 (w), 1523 (w), 1509 (w), 1499 (w), 1490 (w), 1436 (s), 1383 (m), 1341 (w), 1323 (w), 1269 (w), 1242 (w), 1193 (s), 1166 (vs), 1101 (m), 1061 (w), 1050 (w), 990 (w), 898 (m), 868 (m), 836 (m), 790 (w), 758 (w), 747 (w), 739 (w), 700 (w), 681 (w), 673 (w), 656 (w), 652 (w), 633 (w), 620 (w), 602 (w), 588 (w), 569 (w), 545 (w), 527 (w), 513 (w), 494 (w), 480 (w), 463 (w), 452 (w), 438 (w), 415 (w), 402 (w), 392 (w), 375 (w).

HRMS (ESI⁺, [M+H]⁺, C₁₃H₂₁O₂⁺) calcd: 209.1536. found: 209.1534.

### Methyl-1,1a,1b,2,5,5a,6,6a-octahydro-2,5-methanocyclopropa[α]indene-1-carboxylate (Compound (26))

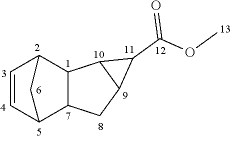

The title compound was prepared according to the general procedure starting from dicyclopentadiene (150 mg, 1.14 mmol) and Rh₂(TPA)₄ (15.4 mg, 11.0 μmol) in dichloromethane (5.7 mL) and methyl diazoacetate (355 mg, 2.84 mmol, 2.5 equiv.) in dichloromethane (7.1 mL). The crude product was purified by column chromatography (n-pentane/Et₂O, 30:1) to obtain the title compound (81 mg, 397 μmol, 35%) as a colorless oil. The compound needs additional purification.

d.r.=1.2:1.6:1:1.4

R_{f}=0.15, 0.31, 0.34, 0.51 (n-pentane/Et₂O, 30:1).

GC-MS (5% methyl phenyl siloxane, 30 m, 0.25 μm, He): t_{R1}=10.271 min (23.3%, [M]⁺ 204.1), t_{R2}=10.583 min (30.8%, [M]⁺ 204.1), t_{R3}=10.698 min (18.9%, [M]⁺ 204.1), t_{R4}=10.831 min (27.0%, [M]⁺ 204.1).

¹H NMR (400 MHz, CDCl₃, ppm) δ=6.20-6.09 (m, 1H, CH═CH), 5.74-5.51 (m, 1H, CH═CH), 3.72-3.57 (m, 3H, C13-CH₃), 2.88-2.83 (m, 1H), 2.79 (dt, J=8.4, 4.1 Hz, 1H), 2.76-2.71 (m, 1H), 2.67 (ddd, J=7.9, 4.1, 2.9 Hz, 1H), 2.46-2.39 (m, 1H), 2.37-2.30 (m, 1H), 1.76-1.69 (m, 1H), 1.50-1.43 (m, 2H, C8-CH₂), 1.33-1.27 (m, 1H).

¹³C NMR (101 MHz, CDCl₃, ppm) δ=175.04 (C12), 174.31 (C12), 174.00 (C12), 172.78 (C12), 138.94, 138.41, 136.17, 135.83, 135.75, 135.38 (CH═CH), 134.71, 134.67 (CH═CH), 132.91 (CH═CH), 130.29 (CH═CH), 56.59, 56.03, 55.68, 54.64, 53.03, 52.08, 52.03, 51.66, 51.58 (C13), 51.48 (C13), 51.19 (C13), 50.04, 49.98, 49.65, 49.02, 47.38, 47.17, 46.98, 46.66, 45.64, 45.47, 45.40, 42.95, 39.65, 38.37, 34.81, 34.67, 33.44, 33.22, 32.55, 31.61, 31.49, 31.46, 30.89, 30.68, 30.29, 29.95, 29.90, 29.15, 28.10, 27.06, 25.06, 24.17, 23.54, 23.46, 21.28, 15.56.

IR (ATR, cm⁻¹) \tilde{v}=3047 (vw), 3030 (vw), 2951 (m), 2866 (w), 2184 (vw), 2179 (vw), 2128 (vw), 2116 (vw), 2105 (vw), 2091 (vw), 2081 (vw), 2068 (vw), 2058 (vw), 2053 (vw), 2047 (vw), 2027 (vw), 2019 (vw), 1999 (vw), 1985 (vw), 1977 (vw), 1949 (vw), 1942 (vw), 1932 (vw), 1919 (vw), 1912 (vw), 1904 (vw), 1891 (vw), 1881 (vw), 1873 (vw), 1857 (vw), 1850 (vw), 1843 (vw), 1826 (vw), 1817 (vw), 1807 (vw), 1781 (vw), 1773 (vw), 1724 (vs), 1664 (w), 1655 (w), 1615 (w), 1572 (w), 1560 (w), 1547 (w), 1536 (w), 1528 (w), 1520 (w), 1509 (w), 1436 (vs), 1400 (s), 1347 (w), 1320 (m), 1302 (m), 1288 (s), 1268 (s), 1238 (m), 1191 (vs), 1163 (vs), 1147 (vs), 1089 (m), 1054 (m), 1030 (m), 1011 (m), 996 (m), 962 (m), 948 (m), 929 (w), 911 (m), 887 (m), 850 (s), 833 (m), 822 (w), 813 (w), 792 (m), 768 (w), 756 (w), 730 (s), 714 (s), 693 (m), 677 (w), 664 (w), 623 (w), 618 (w), 603 (w), 594 (w), 572 (w), 564 (w), 550 (w), 526 (w), 511 (w), 489 (w), 467 (w), 446 (w), 429 (w), 412 (w), 405 (w), 398 (w), 385 (w).

HRMS (ESI⁺, [M+Na]⁺, C₁₃H₁₆O₂Na) calcd: 227.1048. found: 227.1042.

### Methyl 2-(2-ethoxy-2-oxoethyl)bicyclo[3.1.0]hexane-6-carboxylate (Compound (24))

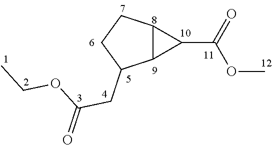 [SMILES: CCOC(=O)CC1CCC2C(C(=O)OC)C12]

The title compound was prepared according to the general procedure starting from ethyl 2-(cyclopentene-2-en-1-yl)acetate (SULTANENE®, 150 mg, 973 μmol) and Rh₂(TPA)₄ (13.2 mg, 10.0 μmol) in dichloromethane (4.9 mL) and methyl diazoacetate (304 mg, 2.43 mmol, 2.5 equiv.) in dichloromethane (6.1 mL). The crude product was purified by column chromatography (n-pentane/Et₂O, 10:1) to obtain the title compound (81 mg, 397 μmol, 35%) as a colorless oil. The compound needs additional purification. 15

d.r.=1:3.6:3.3

R_{f}=0.24, 0.31 (n-pentane/Et₂O, 10:1).

GC-MS (5% methyl phenyl siloxane, 30 m, 0.25 μm, He): t_{R1}=10.423 min (12.6%, [M]⁺ 226.1), t_{R2}=10.542 min (45.4%, [M]⁺ 226.1), t_{R3}=10.763 min (42.0%, [M]⁺ 226.1).

¹H NMR (400 MHz, CDCl₃, ppm) δ=4.12 (qdd, J=7.2, 3.5, 1.2 Hz, 2H, C2-CH₂), 3.68-3.60 (m, 3H, C12-CH₃), 2.77-2.16 (m, 3H, C4-CH₂, C5-CH), 2.08-1.31 (m, 7H, 3×H_{Cpr}, 2×CH_{2 Cp}), 1.24 (tdd, J=7.2, 3.3, 1.9 Hz, 3H, C1-CH₃).

¹³C NMR (101 MHz, CDCl₃, ppm) δ=174.29, 174.16, 173.67 (C11), 172.94, 172.88, 172.77, 172.58, 171.89 (C3), 60.52, 60.44, 60.26 (C2), 54.09, 52.45, 52.34, 51.78, 51.71 (C12), 41.04, 39.59, 38.06, 37.55, 36.85, 36.74, 35.68, 34.25, 33.06 (C_{Cpr}), 32.51, 29.99, 29.78, 29.09, 28.64, 28.14, 27.99, 27.31, 26.64, 26.21, 25.93, 25.20, 24.60, 24.25, 23.72, 22.71, 22.46, 22.07, 18.91, 14.38, 14.34, 14.18 (C1).

IR (ATR, cm⁻¹) \tilde{v}=2979 (w), 2952 (w), 2871 (vw), 1724 (vs), 1655 (w), 1629 (w), 1560 (vw), 1553 (vw), 1528 (vw), 1438 (s), 1407 (m), 1373 (m), 1339 (w), 1299 (m), 1258 (s), 1167 (vs), 1147 (vs), 1095 (m), 1069 (m), 1030 (s), 972 (w), 962 (w), 935 (w), 888 (w), 846 (m), 822 (w), 807 (w), 788 (w), 762 (w), 724 (w), 687 (w), 677 (w), 656 (w), 633 (w), 592 (w), 584 (w), 558 (w), 548 (w), 526 (w), 511 (w), 504 (w), 470 (w), 463 (w), 449 (w), 429 (w), 421 (w), 411 (w), 397 (w), 380 (w).

HRMS (ESI⁺, [M+Na]⁺, C₁₂H₁₈O₂Na) calcd: 249.1103. found: 249.1094.

### Methyl 2-(2-acetoxy-6-methylhepten-5-en-2-yl)cyclopropane-1-carboxylate (Compound (27))

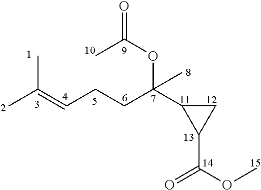 [SMILES: COC(=O)C1CC1C(C)(CCC=C(C)C)OC(C)=O]

The title compound was prepared according to the general procedure starting from 3,7-dimethylocta-1,6-dien-3-yl acetate (150 mg, 764 μmol) and Rh₂(TPA)₄ (10.4 mg, 8.0 μmol) in dichloromethane (3.8 mL) and methyl diazoacetate (251 mg, 1.91 mmol, 2.5 equiv.) in dichloromethane (4.8 mL). The crude product was purified by column chromatography (n-pentane/Et₂O, 10:1) to obtain the title compound (81 mg, 287 μmol, 37%) as a yellow oil. The compound needs additional purification and is not stable under the conditions employed in GC-MS measurements.

R_{f}=0.27, 0.35 (n-pentane/Et₂O, 10:1).

GC-MS (5% methyl phenyl siloxane, 30 m, 0.25 μm, He): t_{R1}=9.493 min ([M-C₂H₄O₂]⁺ 208.1).

¹H NMR (400 MHz, CDCl₃, ppm) δ=5.12-4.96 (m, 1H, C4-CH), 3.80-3.52 (m, 3H, C15-CH₃), 2.10-0.73 (m, 16H, including 1.90-1.83 (m, 2H, C5-CH₂).

¹³C NMR (101 MHz, CDCl₃, ppm) δ=174.66, 174.57, 173.36, 172.26, 172.09, 170.27, 170.12, 170.00, 169.89, 169.84, 169.50 (C9), 161.74, 142.02, 141.89, 141.74, 139.75, 132.04, 131.93, 131.85, 130.47, 124.01, 123.86, 123.77 (C4), 113.39, 113.31, 113.25, 83.12, 82.96, 81.84, 81.56, 81.41, 66.23, 53.41, 53.32, 52.62, 52.24, 52.05, 51.97, 51.89, 51.50, 51.14 (C15), 40.17, 39.65, 39.52, 39.00, 38.77, 33.83, 33.59, 32.82, 30.61, 30.41, 30.04, 29.81, 29.17, 28.39, 27.85, 25.79, 25.68, 24.01, 23.78, 23.69, 23.35, 23.29, 22.94, 22.83, 22.63, 22.45, 22.35, 22.28, 22.21, 22.04, 21.90, 21.17, 21.04, 19.58, 18.49, 17.73, 17.68, 17.63, 17.57, 17.22, 16.41, 14.22, 14.18, 12.21, 11.05, 10.59, 9.26.

IR (ATR, cm⁻¹) \tilde{v}=2952 (w), 2931 (w), 2918 (w), 2871 (w), 2861 (w), 2111 (w), 1728 (vs), 1649 (w), 1567 (w), 1526 (w), 1507 (w), 1438 (s), 1401 (w), 1367 (s), 1329 (m), 1241 (vs), 1215 (vs), 1194 (vs), 1171 (vs), 1113 (s), 1086 (s), 1047 (m), 1018 (s), 936 (m), 921 (m), 891 (m), 850 (m), 837 (m), 793 (m), 769 (m), 744 (m), 727 (w), 705 (w), 686 (w), 670 (w), 609 (m), 569 (w), 554 (w), 545 (w), 535 (w), 517 (w), 489 (w), 480 (w), 462 (w), 449 (w), 439 (w), 422 (w), 402 (w), 392 (w), 385 (w), 377.

HRMS (ESI⁺, [M+Na]⁺, C₁₅H₂₄O₂Na) calcd: 291.1572. found: 291.1565.

### Methyl 2-(6-acetoxy-6-methylheptan-2-yl)cyclopropane-1-carboxylate (Compound (28))

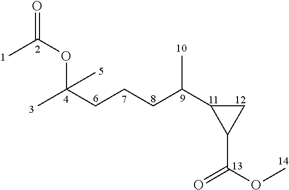 [SMILES: COC(=O)C1CC1C(C)CCCC(C)(C)OC(C)=O]

The title compound was prepared according to the general procedure starting from 2,6-dimethyloct-7-en-2-yl acetate (150 mg, 756 μmol) and Rh₂(TPA)₄ (10.3 mg, 8.0 μmol) in dichloromethane (3.8 mL) and methyl diazoacetate (237 mg, 1.89 mmol, 2.5 equiv.) in dichloromethane (4.7 mL). The crude product was purified by column chromatography (n-pentane/Et₂O, 10:1) to obtain the title compound (123 mg, 455 μmol, 60%) as a yellow oil. The compound needs additional purification and is not stable under the conditions employed in GC-MS measurements.

R_{f}=0.23, 0.29, 0.35 (n-pentane/Et₂O, 10:1).

GC-MS (5% methyl phenyl siloxane, 30 m, 0.25 μm, He): t_{R1}=9.236 min (main peak, [M-C₂H₄O₂]⁺ 210.1).

¹H NMR (400 MHz, CDCl₃, ppm) δ=3.69-3.63 (m, 3H, C14-CH₃), 1.95 (s, 3H, C1-CH₃), 1.74-1.31 (m, 12H, C3-CH₃, C5-CH₃, C6-CH₂, C7-CH₂, C9-CH, H_{Cpr}), 1.29-1.21 (m, 1H, H_{Cpr}), 1.18-0.65 (m, 7H, C8-CH₂, C10-CH₃, 2×H_{Cpr}).

¹³C NMR (101 MHz, CDCl₃, ppm) δ=175.25, 175.03, 173.84, 170.64, 170.27, 169.50, 133.54, 130.47, 127.87, 82.54, 82.47, 66.24, 53.40, 53.32, 52.62, 52.44, 52.33, 52.24, 51.76, 51.71, 51.63 (C14), 41.17, 41.12, 40.99, 37.84, 37.73, 37.35, 37.20, 37.16, 37.11, 31.54, 31.02, 29.93, 29.82, 29.36, 26.16, 26.12, 22.59, 22.56, 22.46 (C1), 21.60, 21.52, 21.36, 21.27, 20.41, 20.35, 20.12, 19.65, 19.49, 19.01, 18.77, 17.46, 15.67, 14.17, 13.96, 13.93, 12.54.

IR (ATR, cm⁻¹) \tilde{v}=3000 (vw), 2952 (w), 2871 (w), 2850 (w), 1725 (vs), 1598 (w), 1571 (w), 1531 (w), 1521 (w), 1517 (w), 1507 (w), 1436 (m), 1400 (w), 1366 (s), 1305 (w), 1258 (vs), 1196 (vs), 1167 (vs), 1084 (m), 1044 (m), 1017 (s), 984 (w), 942 (m), 918 (m), 881 (w), 866 (w), 843 (w), 824 (m), 781 (w), 764 (w), 745 (w), 728 (w), 701 (w), 686 (w), 662 (w), 640 (w), 628 (w), 611 (m), 584 (w), 558 (w), 535 (w), 528 (w), 517 (w), 509 (w), 493 (w), 480 (w), 467 (w), 455 (w), 449 (w), 441 (w), 429 (w), 425 (w), 418 (w), 402 (w), 394 (w), 378 (w).

HRMS (ESI⁺, [M+Na]⁺, C₁₅H₂₆O₂Na) calcd: 293.1729. found: 293.1719.

### Methyl 2-(cyclohex-3-en-1-yl)cyclopropane-1-carboxylate (Compound (22))

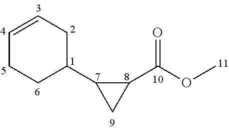

The title compound was prepared according to the procedure starting from 4-vinyl-1-cyclohexene (150 mg, 1.39 mmol) and Rh₂(TPA)₄ (18.8 mg, 14.0 μmol) in dichloromethane (6.9 mL) and methyl diazoacetate (434 mg, 3.47 mmol, 2.5 equiv.) in dichloromethane (8.7 mL). The crude product was purified by column chromatography (n-pentane/Et₂O, 30:1) to obtain the title compound (115 mg, 640 μmol, 46%) as a colorless oil.

d.r.=1:1.2

R_{f}=0.41, 0.50 (n-pentane/Et₂O, 30:1).

GC-MS (5% Methyl phenyl siloxane, 30 m, 0.25 μm, He): t_{R1}=9.096 min (45%, [M]⁺ 180.1), t_{R2}=9.448 min (55%, [M]⁺ 180.1).

¹H NMR (400 MHz, CDCl₃, ppm) δ=5.70-5.57 (m, 1H, CH═CH), 5.00-4.83 (m, 1H, CH═CH), 3.68-3.61 (m, 3H, C11-CH₃), 2.19-1.76 (m, 4H, C2/C5-CH₂), 1.72-0.71 (m, 7H, C6-CH₂, C1-CH, C7-CH_{Cpr}, C8-CH_{Cpr}, C9-CH_{2 Cpr}).

¹³C NMR (101 MHz, CDCl₃, ppm) δ=175.19, 175.14, 175.10, 173.77, 173.73, 172.49, 172.38 (C10), 144.88, 144.19, 143.54, 143.34, 127.14, 127.07 (CH═CH), 126.29, 126.11, 112.93, 112.69, 112.44, 112.41 (CH═CH), 51.76, 51.73, 51.67, 51.28 (C11), 38.17, 37.83, 37.74, 37.71, 36.10, 35.55, 31.83, 31.63, 31.24, 31.06, 29.50, 28.79, 28.72, 28.67, 28.36, 28.18, 28.15, 28.09, 28.05, 27.60, 26.92, 26.10, 26.01, 25.71, 25.27, 25.04, 25.01, 24.94, 24.78, 24.45, 23.41, 22.90, 22.84, 22.49, 22.36, 22.26, 21.35, 21.27, 19.43, 18.99, 18.83, 18.06, 17.89, 17.79, 17.35, 16.78, 15.80, 14.50, 14.29, 14.19, 12.91, 12.72.

IR (ATR, cm⁻¹) \tilde{v}=3020 (w), 3002 (vw), 2970 (vw), 2948 (w), 2921 (w), 2853 (w), 2840 (w), 1725 (vs), 1650 (w), 1639 (w), 1612 (w), 1585 (w), 1578 (w), 1571 (w), 1561 (w), 1553 (w), 1544 (w), 1534 (w), 1523 (w), 1517 (w), 1509 (w), 1499 (w), 1490 (w), 1436 (s), 1404 (w), 1381 (m), 1368 (w), 1332 (w), 1312 (m), 1296 (w), 1286 (w), 1268 (m), 1249 (w), 1221 (w), 1191 (vs), 1167 (vs), 1081 (m), 1043 (m), 1024 (w), 993 (m), 960 (m), 942 (w), 909 (s), 888 (m), 874 (w), 866 (w), 851 (w), 824 (m), 803 (m), 789 (w), 778 (w), 756 (w), 739 (w), 721 (m), 684 (w), 653 (s), 615 (w), 591 (w), 578 (w), 562 (w), 545 (w), 540 (w), 528 (w), 514 (w), 500 (w), 490 (w), 479 (w), 470 (w), 458 (w), 446 (w), 436 (w), 428 (w), 411 (w), 394 (w), 378 (w).

HRMS (ESI⁺, [M+H]⁺, C₁₁H₁₇O₂⁺) calcd: 181.1223. found: 181.1220.

### Methyl bicyclo[4.1.0]heptane-7-carboxylate (Compound (14))

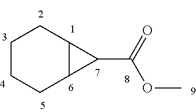

The title compound was prepared according to the general procedure starting from cyclohexene (150 mg, 1.83 mmol) and Rh₂(TPA)₄ (24.8 mg, 18.0 μmol) in dichloromethane (9.1 mL) and methyl diazoacetate (571 mg, 4.57 mmol, 2.5 equiv.) in dichloromethane (11.4 mL). The crude product was purified by column chromatography (n-pentane/Et₂O, 30:1) to obtain the title compound (241 mg, 1.57 mmol, 86%) as a colorless oil.

d.r.=1:1.9

R_{f}=0.34, 0.59 (n-pentane/Et₂O, 30:1).

GC-MS (5% methyl phenyl siloxane, 30 m, 0.25 μm, He): t_{R1}=7.578 min (34%, [M]⁺ 154.1), t_{R2}=7.842 min (66%, [M]⁺ 154.1).

¹H NMR (400 MHz, CDCl₃, ppm) δ=3.65 (s, 3H, C9-CH₃), 1.95-1.80 (m, 2H, CH_{2 Cy}), 1.74-1.61 (m, 3H, CH2 cy, C1/C6-CH), 1.58 (ddt, J=4.1, 3.0, 1.6 Hz, 1H, C1/C6-CH), 1.38 (t, J=4.3 Hz, 1H, C7-CH), 1.33-1.10 (m, 4H, 2×CH_{2 Cy}).

¹³C NMR (101 MHz, CDCl₃, ppm) δ=175.45, 172.54 (C8), 51.61, 51.22 (C9), 25.63, 22.84 (C_{Cpr}), 22.38, 22.06 (C_{Cpr}), 21.32, 21.05, 18.66, 16.69 (C_{Cpr}).

IR (ATR, cm⁻¹) \tilde{v}=3014 (vw), 2929 (m), 2856 (w), 1723 (vs), 1655 (w), 1649 (w), 1630 (vw), 1619 (vw), 1612 (vw), 1579 (vw), 1561 (vw), 1553 (vw), 1544 (vw), 1534 (vw), 1528 (vw), 1523 (vw), 1509 (vw), 1438 (vs), 1422 (w), 1378 (w), 1350 (w), 1306 (vs), 1283 (w), 1265 (m), 1193 (vs), 1183 (s), 1166 (vs), 1152 (vs), 1081 (m), 1048 (m), 1018 (m), 960 (s), 950 (m), 916 (m), 866 (w), 851 (w), 839 (w), 815 (w), 793 (w), 779 (s), 715 (m), 703 (m), 660 (w), 652 (w), 632 (w), 609 (w), 599 (w), 589 (w), 574 (w), 564 (w), 555 (w), 547 (w), 528 (w), 510 (w), 494 (w), 489 (w), 482 (w), 475 (w), 460 (w), 433 (w), 419 (w), 411 (w), 404 (w), 390 (w).

HRMS (ESI⁺, [M+H]⁺, C₉H₁₅O₂⁺) calcd: 155.1067. found: 155.1064.

### Methyl 3-methylbicyclo[4.1.0]heptane-7-carboxylate (Compound (13))

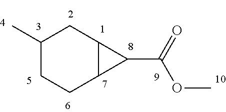

The title compound was prepared according to the general procedure starting from 4-methyl-1-cyclohexene (150 mg, 1.56 mmol) and Rh₂(TPA)₄ (21.1 mg, 16.0 μmol) in dichloromethane (7.8 mL) and methyl diazoacetate (488 mg, 3.89 mmol, 2.5 equiv.) in dichloromethane (9.8 mL). The crude product was purified by column chromatography (n-pentane/Et₂O, 30:1) to obtain the title compound (151 mg, 898 μmol, 58%) as a colorless oil.

d.r.=1.4:1

R_{f}=0.49, 0.69 (n-pentane/Et₂O, 30:1).

GC-MS (5% methyl phenyl siloxane, 30 m, 0.25 μm, He): t_{R1}=7.970 min (59%, [M]⁺ 168.1), t_{R2}=8.309 min (41%, [M]⁺ 168.1).

¹H NMR (400 MHz, CDCl₃, ppm) δ=3.66-3.61 (m, 3H, C10-CH₃), 2.14-0.87 (m, 10H, C8-CH, C7-CH, 3×CH_{2 Cy}, C3-CH, C1-CH), 0.86-0.77 (m, 3H, C4-CH₃).

¹³C NMR (101 MHz, CDCl₃, ppm) δ=175.39 (C9), 51.62 (C10), 51.22, 32.19, 31.52, 30.59, 29.40, 28.86, 28.82, 28.56, 28.12, 26.93, 26.54, 26.26, 26.17, 25.74, 24.10, 23.29, 23.05, 22.93, 22.70, 22.44, 22.36, 22.26, 22.12 (C4), 22.08, 21.39, 19.88, 18.72, 18.27, 17.23, 17.18, 15.80.

IR (ATR, cm⁻¹) \tilde{v}=3014 (vw), 2949 (w), 2922 (m), 2867 (w), 2853 (w), 1724 (vs), 1655 (w), 1649 (w), 1639 (w), 1630 (w), 1619 (w), 1611 (w), 1587 (vw), 1578 (vw), 1571 (vw), 1561 (vw), 1544 (vw), 1534 (vw), 1528 (vw), 1517 (vw), 1509 (vw), 1499 (vw), 1490 (vw), 1438 (vs), 1377 (w), 1346 (w), 1330 (w), 1313 (s), 1296 (m), 1286 (m), 1264 (m), 1231 (w), 1191 (vs), 1169 (vs), 1153 (vs), 1089 (w), 1054 (m), 987 (w), 963 (m), 922 (m), 899 (w), 891 (w), 863 (w), 840 (w), 827 (w), 802 (m), 772 (w), 748 (w), 707 (m), 654 (w), 626 (w), 611 (w), 603 (w), 599 (w), 589 (w), 578 (w), 565 (w), 551 (w), 540 (w), 531 (w), 526 (w), 520 (w), 503 (w), 496 (w), 463 (w), 450 (w), 436 (w), 421 (w), 416 (w), 404 (w), 382 (w).

HRMS (ESI⁺, [M+H]⁺, C₁₀H₁₇O₂⁺) calcd: 169.1223. found: 169.1221.

### Methyl 2-(cyclohexylmethyl)cyclopropane-1-carboxylate (Compound (31))

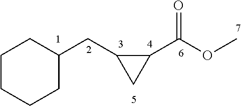

The title compound was prepared according to the general procedure starting from allylcyclohexane (150 mg, 1.21 mmol) and Rh₂(TPA)₄ (16.4 mg, 12.0 mmol) in dichloromethane (6.0 mL) and methyl diazoacetate (378 mg, 3.02 mmol, 2.5 equiv.) in dichloromethane (7.5 mL). The crude product was purified by column chromatography (n-pentane/Et₂O, 30:1) to obtain the title compound (186 mg, 949 μmol, 79%) as a colorless oil.

d.r.=1:2.3

R_{f}=0.39, 0.49 (n-pentane/Et₂O, 30:1).

GC-MS (5% methyl phenyl siloxane, 30 m, 0.25 μm, He): t_{R1}=9.455 min (30.4%, [M]⁺ 197.1), t_{R2}=9.543 min (69.6%, [M]⁺ 197.1).

¹H NMR (400 MHz, CDCl₃, ppm) δ=3.66 (s, 3H, C7-CH₃), 1.78-0.80 (m, 16H, including 1.66-1.61 (m, 2H, C2-CH₂), 1.36-1.29 (m, 1H, C4-CH), 1.17-1.10 (m, 2H, 2×H_{Cpr}), C1-CH, 5×CH_{2 Cy}), 0.67 (ddd, J=8.1, 6.4, 4.0 Hz, 1H, H_{Cpr}).

¹³C NMR (101 MHz, CDCl₃, ppm) δ=175.24, 173.76 (C6), 51.75, 51.62 (C7), 41.12, 38.43, 38.16, 34.53, 33.42, 33.34, 33.26, 29.73, 26.74, 26.69, 26.54, 26.51, 26.43, 21.23, 20.35, 20.23 (C_{Cpr}), 18.19, 15.95 (C_{Cpr}), 13.70.

IR (ATR, cm⁻¹) \tilde{v}=2921 (s), 2850 (m), 1728 (vs), 1691 (w), 1664 (w), 1656 (w), 1642 (w), 1630 (w), 1619 (w), 1596 (w), 1578 (w), 1571 (vw), 1560 (w), 1543 (w), 1534 (w), 1527 (w), 1509 (w), 1499 (vw), 1446 (s), 1436 (s), 1401 (w), 1383 (m), 1356 (w), 1349 (w), 1323 (w), 1309 (w), 1268 (m), 1193 (vs), 1167 (vs), 1082 (m), 1045 (m), 1033 (w), 970 (w), 958 (w), 928 (w), 890 (m), 875 (m), 866 (m), 841 (m), 822 (m), 809 (w), 786 (w), 775 (w), 765 (w), 737 (w), 707 (w), 683 (w), 666 (w), 633 (w), 620 (w), 611 (w), 596 (w), 588 (w), 581 (w), 565 (w), 551 (w), 537 (w), 516 (w), 499 (w), 486 (w), 473 (w), 452 (w), 435 (w), 422 (w), 415 (w), 399 (w), 381 (w).

HRMS (ESI⁺, [M+H]⁺, C₁₂H₂₁O₂⁺) calcd: 197.1536. found: 197.1533.

### Methyl 2-(cyclopentylmethyl)cyclopropane-1-carboxylate (Compound (33))

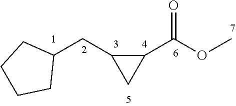

The title compound was prepared according to the general procedure starting from allylcyclopentane (150 mg, 1.36 mmol) and Rh₂(TPA)₄ (18.5 mg, 14.0 μmol) in dichloromethane (6.8 mL) and methyl diazoacetate (426 mg, 3.40 mmol, 2.5 equiv.) in dichloromethane (8.5 mL). The crude product was purified by column chromatography (n-pentane/Et₂O, 30:1) to obtain the title compound (198 mg, 1.09 mmol, 80%) as a colorless oil.

d.r.=1:3.5

R_{f}=0.37, 0.49 (n-pentane/Et₂O, 30:1).

GC-MS (5% methyl phenyl siloxane, 30 m, 0.25 μm, He): t_{R1}=8.834 min (22.2%, [M]⁺ 182.1), t_{R2}=9.015 (77.8%, [M]⁺ 182.1).

¹H NMR (400 MHz, CDCl₃, ppm) δ=3.66 (s, 3H, C7-CH₃), 1.90-0.88 (m, 14H, 4×CH2 Cp, 3×H_{Cpr}, C1-CH, C2-CH₂), 0.72-0.66 (m, 1H, H_{Cpr}).

¹³C NMR (101 MHz, CDCl₃, ppm) δ=175.22, 173.76 (C6), 51.74, 51.63 (C7), 40.72, 40.43, 39.40, 32.96, 32.74, 32.69, 32.59, 32.57, 25.28, 25.19, 25.13, 22.61, 21.49, 20.24, 18.16, 15.80 (C_{Cpr}), 13.67.

IR (ATR, cm⁻¹) v=3004 (vw), 2948 (m), 2910 (w), 2866 (w), 1728 (vs), 1691 (w), 1656 (w), 1649 (w), 1639 (w), 1629 (w), 1619 (w), 1611 (vw), 1604 (Vw), 1596 (Vw), 1587 (vw), 1579 (vw), 1571 (vw), 1560 (vw), 1543 (w), 1534 (w), 1528 (w), 1517 (vw), 1509 (vw), 1436 (s), 1401 (w), 1381 (m), 1360 (w), 1344 (m), 1316 (w), 1268 (m), 1242 (w), 1193 (vs), 1163 (vs), 1096 (m), 1082 (m), 1044 (m), 970 (w), 939 (w), 914 (m), 882 (w), 864 (m), 846 (w), 823 (m), 775 (w), 737 (w), 683 (w), 666 (w), 629 (w), 612 (w), 606 (w), 582 (w), 568 (w), 561 (w), 550 (w), 533 (w), 526 (w), 507 (w), 482 (w), 472 (w), 458 (w), 448 (w), 436 (w), 416 (w), 409 (w), 401 (w), 391 (w), 381 (W).

HRMS (ESI⁺, [M+H]⁺, C₁₁H₁₉O₂⁺) calcd.: 183.1380. found: 183.1378.

### (2-methyl-3-((2,2,3-trimethylcyclopentyl)methyl)cyclopropyl)methanol (Compound (16))

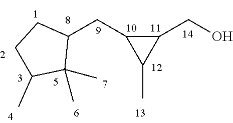

A solution of ethyl 2-methyl-3-((2,2,3-trimethylcyclopentyl)methyl)cyclopropane-1-carboxylate (150 mg, 594 μmol, 1.0 equiv.) in dry Et₂O (5 mL) was slowly added to a refluxing suspension of LiAlH₄ (30.0 mg, 790 μmol, 1.3 equiv.) in dry Et₂O (10 mL). The mixture was heated to reflux for 1 h. After completion of the reaction (TLC control) the reaction mixture was cooled in an ice-bath and ethyl acetate (50 mL) and water (50 mL) were alternately slowly added with caution. The organic layer was separated and the water layer was extracted with ethyl acetate (3×25 mL). The combined organic layers were washed with water (2×25 mL). The organic layer was dried over sodium sulphate and the solvent was evaporated in vacuo. The resulting oil was purified by column chromatography (Cyclohexane/EtOAc, 4:1) to yield the title compound (71.8 mg, 341 μmol, 57%) as a light-yellow oil.

d.r.=3.5:6.5:1:2.3

R_{f}=0.45 (Cyclohexane/EtOAc, 4:1).

GC-MS (5% methyl phenyl siloxane, 30 m, 0.25 μm, He): t_{R1}=10.117 min (26.2%, [M-CH₃]⁺ 195.1), t_{R2}=10.240 min (49.0%, [M-CH₃]⁺ 195.1), t_{R3}=10.544 min (7.5%, [M-CH₃]⁺ 195.1), t_{R4}=10.588 min (17.3%, [M-CH₃]⁺ 195.1).

¹H NMR (400 MHz, CDCl₃, ppm) δ=3.78-3.37 (m, 2H, C14-CH₂), 1.96-0.39 (m, 23H).

### (2-methyl-3-((2,2,3-trimethylcyclopent-3-en-1-yl)methyl)cyclopropyl)methanol (Compound 32))

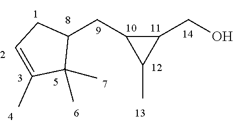

A solution of ethyl 2-methyl-3-((2,2,3-trimethylcyclopent-3-en-1-yl)methyl)cyclopropane-1-carboxylate (104 mg, 416 μmol, 1.0 equiv.) in dry Et₂O (5 mL) was slowly added to a refluxing suspension of LiAlH₄ (19.0 mg, 499 μmol, 1.2 equiv.) in dry Et₂O (10 mL). The mixture was heated to reflux for 1 h. After completion of the reaction (TLC control) the reaction mixture was cooled in an ice-bath and ethyl acetate (50 mL) and water (50 mL) were alternately slowly added with caution. The organic layer was separated and the water layer was extracted with ethyl acetate (3×25 mL). The combined organic layers were washed with water (2×25 mL). The organic layer was dried over sodium sulphate and the solvent was evaporated in vacuo. The resulting oil was purified by column chromatography (Cyclohexane/EtOAc, 4:1) to yield the title compound (75.8 mg, 364 μmol, 87%) as a light-yellow oil.

d.r.=1:1:1.1:2.8:3.8

R_{f}=0.48 (Cyclohexane/EtOAc, 4:1).

GC-MS (5% methyl phenyl siloxane, 30 m, 0.25 μm, He): t_{R1}=10.166 min (10.3%, [M]⁺ 208.1), t_{R2}=10.273 min (10.4%, [M]⁺ 208.1), t_{R3}=10.318 min (11.0%, [M]⁺ 208.1), t_{R4}=10.408 min (28.5%, [M-CH₃]⁺ 193.2), t_{R5}=10.596 min (39.8%, [M-CH₃]⁺ 193.2).

¹H NMR (400 MHz, CDCl₃, ppm) δ=5.46-5.27 (m, 1H, C2-CH), 3.99-3.57 (m, 2H, C14-CH₂), 2.45-0.42 (m, 21H, including 1.60 (s, 3H, C4-CH₃).

¹³C NMR (101 MHz, CDCl₃, ppm) δ=148.91, 148.85 (C2/C3), 130.29, 125.19, 123.95, 123.87, 121.98, 121.93, 121.88, 67.53, 67.49, 63.78, 60.72, 59.87, 59.67, 51.48, 51.15, 51.08, 50.99, 48.24, 46.98, 46.91, 46.82, 45.18, 43.05, 35.84, 35.73, 34.27, 33.96, 32.53, 31.61, 29.84, 29.08, 29.01, 28.72, 28.12, 27.58, 27.46, 27.41, 26.00, 25.95, 25.89, 25.86, 25.00, 24.12, 23.15, 23.03, 22.48, 22.17, 22.11, 21.12, 20.71, 20.46, 20.23, 20.08, 20.01, 19.82, 19.68, 19.63, 18.33, 17.75, 16.17, 14.99, 14.20, 13.13, 12.97, 12.93, 12.76, 12.62, 12.05, 11.16, 8.26, 7.60.

IR (ATR, cm⁻¹) \tilde{v}=3427 (w), 3384 (w), 3354 (w), 3336 (w), 3327 (w), 3315 (w), 3306 (w), 3292 (w), 3259 (w), 3224 (w), 3203 (w), 2995 (w), 2952 (s), 2925 (vs), 2864 (s), 2775 (w), 1874 (w), 1851 (w), 1832 (w), 1824 (w), 1819 (w), 1806 (w), 1800 (w), 1793 (w), 1782 (w), 1773 (w), 1762 (w), 1752 (w), 1737 (w), 1720 (w), 1708 (w), 1701 (w), 1686 (w), 1676 (w), 1670 (w), 1655 (w), 1649 (w), 1638 (w), 1629 (w), 1618 (w), 1609 (w), 1598 (w), 1578 (w), 1571 (w), 1561 (w), 1544 (w), 1534 (w), 1523 (w), 1509 (w), 1459 (s), 1443 (s), 1402 (m), 1383 (s), 1360 (s), 1324 (m), 1299 (m), 1283 (m), 1251 (m), 1220 (m), 1214 (m), 1179 (w), 1143 (m), 1113 (m), 1088 (m), 1079 (m), 1068 (m), 1011 (vs), 966 (s), 918 (m), 882 (m), 861 (m), 834 (m), 798 (vs), 754 (s), 703 (s), 657 (s), 628 (s), 608 (s), 584 (s), 550 (s), 527 (s), 518 (m), 506 (m), 500 (m), 476 (m), 469 (m), 462 (m), 449 (m), 425 (m), 418 (m), 408 (m), 399 (m), 388 (m), 380 (m).

HRMS (ESI⁺, [M+H₂O]⁺, C₁₄H₂₃⁺) calcd.: 191.1794. found: 191.1792.

### REFERENCES

Barrett, A. G., Braddock, D. C., Lenoir, I., & Tone, H. (2001). J. Org. Chem., 66 (24), 8260-8263.
Espino, C. G., & Du Bois, J. (2001). Angew. Chem. Int. Ed., 40 (3), 598-600.
Keigo, K., Toshihiro, K., & Noritaka, M. (2010). Chem. Lett., 39, 702-703.
Searle, N. E. (1963). Org. Syn. Coll., 4, 424.
Shaw, M. A., Croft, R. A., Whittingham, W. G., & Bower, J. F. (2015). J. Am. Chem. Soc., 137 (25), 8054-8057.

1-15. (canceled)

16. A method for producing a perfumed product comprising contacting components of the perfumed produce with a sensorially effective amount of one or more compounds of formula (I): 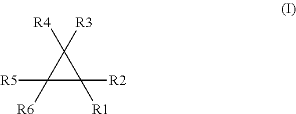
wherein R1 is COOX, wherein X is methyl, ethyl, or tert-butyl, or R1 is CH2OH,
R2 is H or methyl, and
R3 to R6 are defined as shown in compounds (1) to (34) below,

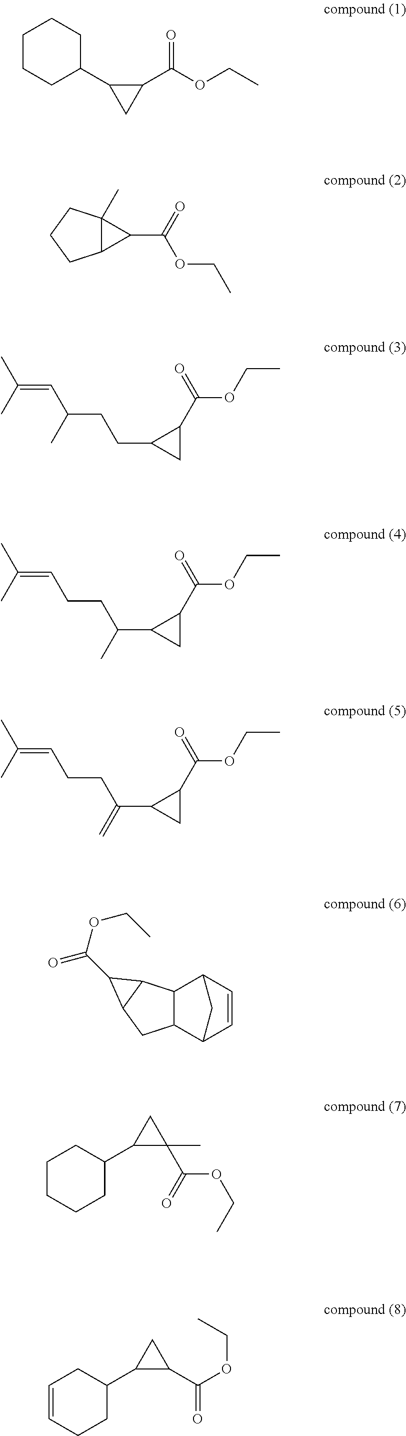

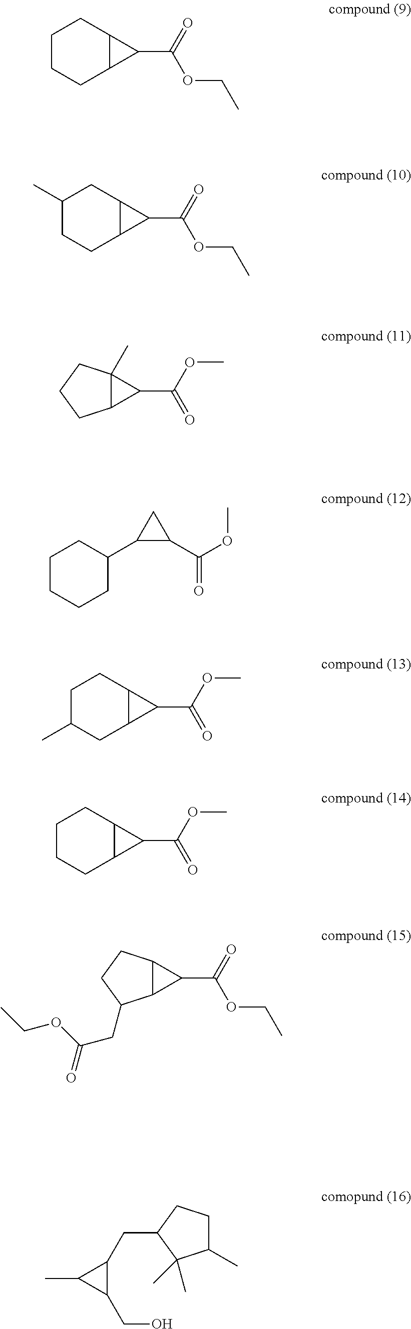

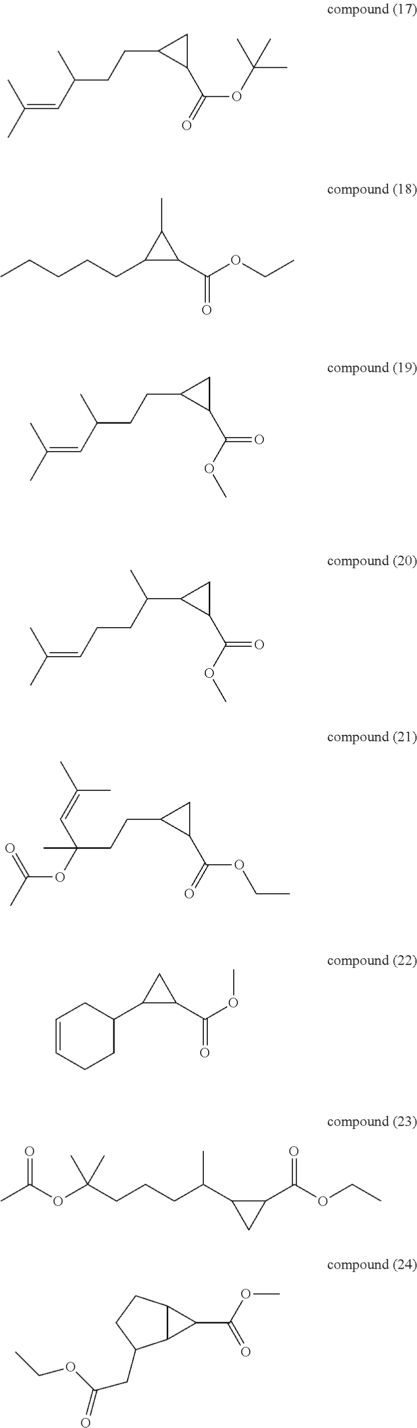

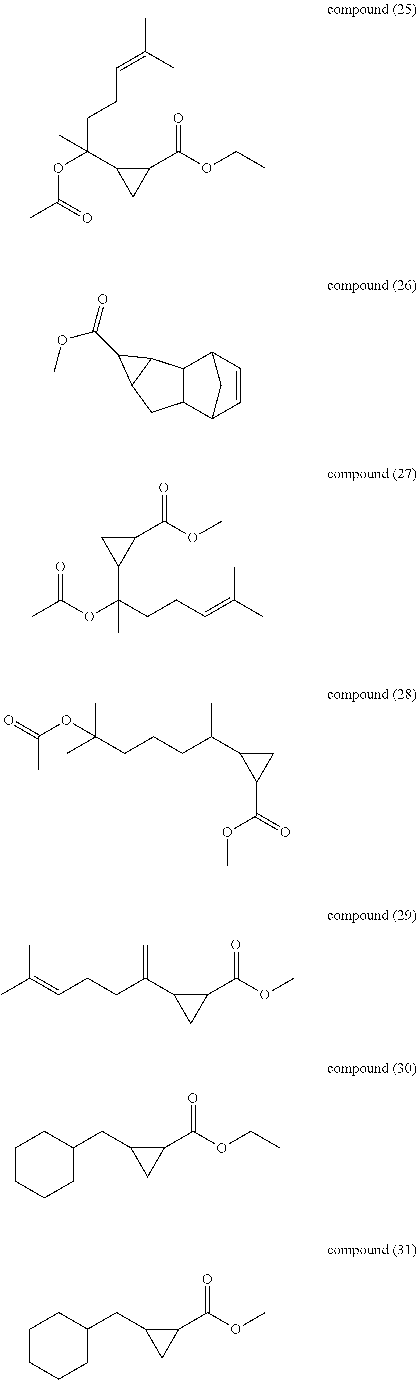

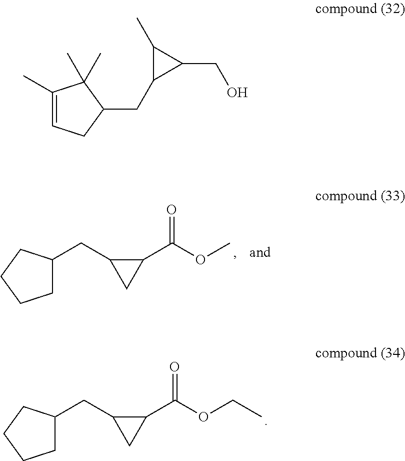

17. The method of claim 16, wherein the one or more compounds of formula (I) are enantiomerically pure, racemic, or mixtures of diastereoisomers.

18. The method of claim 16, wherein the one or more compounds of formula (I) impart a fruity fragrance, a floral fragrance, or a combination thereof.

19. The method of claim 16, wherein:
compound (I) provides one or more olfactory notes selected from fruity, floral, pineapple, ester, or buttery;
compound (2) provides one or more olfactory notes selected from fruity, tropical, raspberry, apple, or floral;
compound (3) provides one or more olfactory notes selected from grapefruit, pineapple, rhubarb, or nature;
compound (4) provides one or more olfactory notes selected from fruity or rhubarb;
compound (5) provides one or more olfactory notes selected from fruity, green, or boiled rhubarb;
compound (6) provides an earthy olfactory note;
compound (7) provides one or more olfactory notes selected from fruity, green, or apricot;
compound (8) provides one or more olfactory notes selected from fruity, strawberry, or pineapple;
compound (9) provides one or more olfactory notes selected from currant, fruity, banana, or buttery;
compound (10) provides one or more olfactory notes selected from green, fruity, banana, or kiwi;
compound (11) provides one or more olfactory notes selected from currant, fruity, banana, or Eisbonbon;
compound (12) provides one or more olfactory notes selected from fruity, flowery, green or leeks;
compound (13) provides one or more olfactory notes selected from fruity, leek, or Eisbonbon;
compound (14) provides one or more olfactory notes selected from fruity, leeks, or Eisbonbon;
compound (15) provides a melon olfactory note;
compound (16) provides a green olfactory note;
compound (17) provides one or more olfactory notes selected from fruity, fresh, flowery, or rosewood;
compound (18) provides a fruity olfactory note;
compound (19) provides one or more olfactory notes selected from rhubarb or nature;
compound (20) provides one or more olfactory notes selected from rhubarb or nature,
compound (21) provides a fruity olfactory note;
compound (22) provides one or more olfactory notes selected from fruity or buttery;
compound (23) provides a fresh olfactory note;
compound (24) provides one or more olfactory notes selected from fresh or fruity;
compound (25) provides a fruity olfactory note;
compound (26) provides a fruity olfactory note;
compound (27) provides a fresh olfactory note;
compound (28) provides a fruity olfactory note;
compound (29) provides one or more olfactory notes selected from nature, garden herbs, or aroma;
compound (30) provides a fruity olfactory note;
compound (31) provides one or more olfactory notes selected from fruity or pineapple;
compound (32) provides one or more olfactory notes selected from creamy, woody, or fruity;
compound (33) provides one or more olfactory notes selected from fruity or pineapple; and/or
compound (34) provides one or more olfactory notes selected from pear or fruity.

20. A perfumed product produced according to the method of claim 16.

21. A fragrance composition or perfumed product comprising one or more compounds of formula (I): 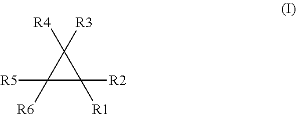
wherein R1 is COOX, wherein X is methyl, ethyl, or tert-butyl, or R1 is CH2OH,
R2 is H or methyl, and
R3 to R6 are defined as shown in compounds (1) to (34) below,

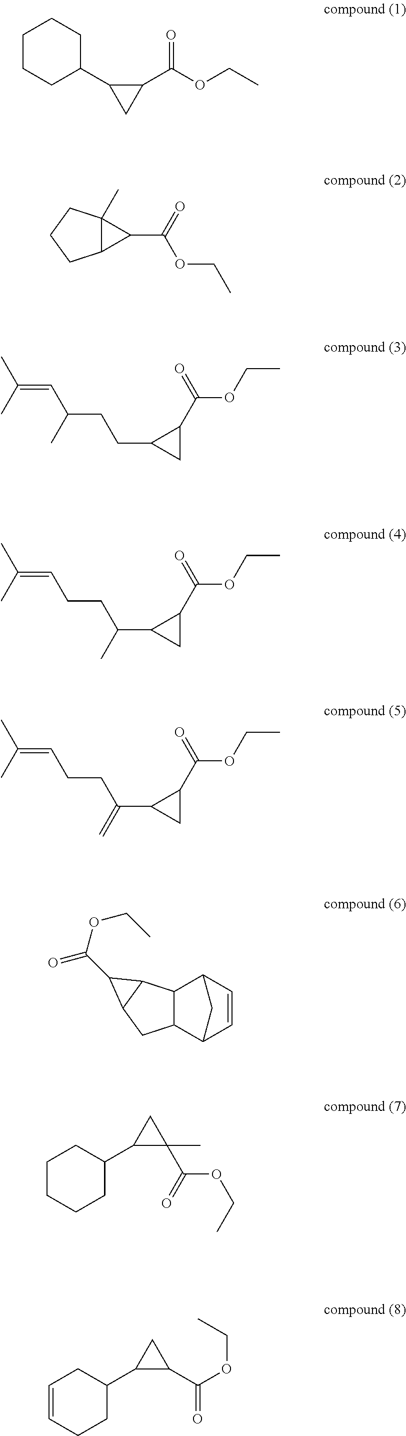

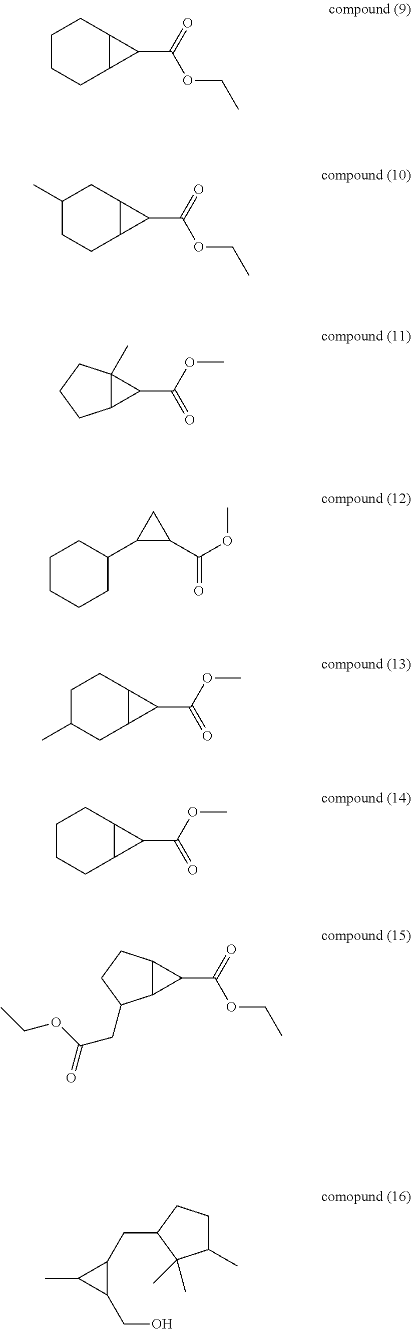

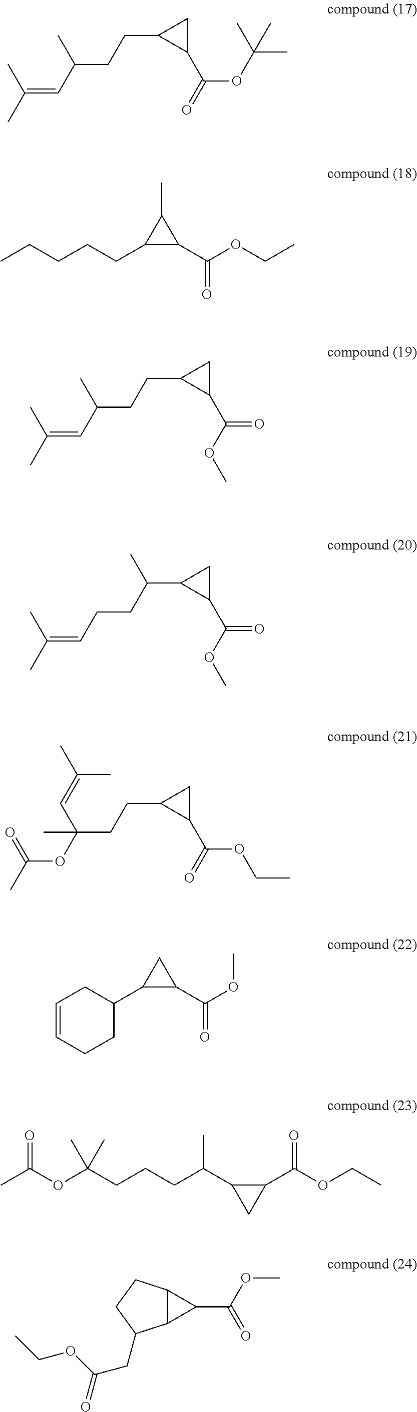

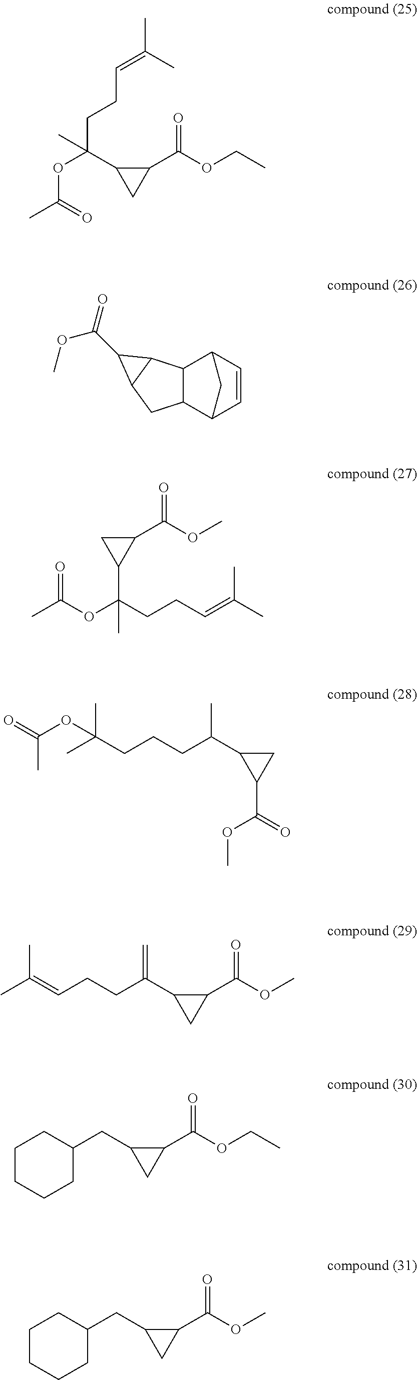

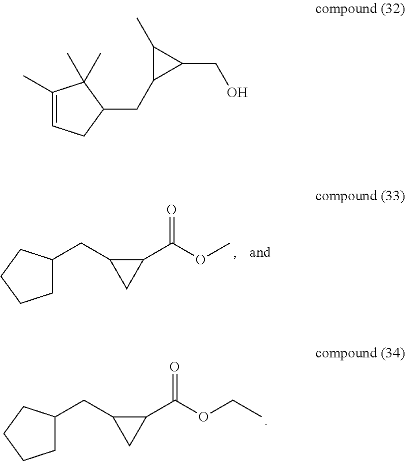

22. The perfumed product of claim 21, wherein the product is selected from perfume extracts, eau de parfums, eau de toilettes, after-shave, eau de colognes, pre-shave-products, splash colognes, perfumed wet wipes, acidic, alkalic or neutral cleaning agents, textile refreshener, iron aids, liquid laundry soaps, laundry soap powders, laundry pre-treatment agents, fabric softeners, cleaning soaps, cleaning tabs, disinfectants, surface disinfectants, air improver, aerosol sprays, waxes or polishes, body care products, hand crèmes or lotions, foot crèmes or lotions, hair removal crèmes or lotions, aftershave crèmes or lotions, tanning crèmes or lotions, hair care products, deodorants or antiperspirants, products of decorative cosmetics, candles, lamp oils, incense sticks, insecticides, repellents or blowing agents.

23. The perfumed product of claim 21, wherein the one or more compounds of formula (I) are in an amount of 0.01 to 10 wt. %, based on a total weight of the product.

24. The perfumed product of claim 21, wherein the one or more compounds of formula (I) are in an amount of 0.01 to 7 wt. %, based on a total weight of the product.

25. A method for producing a compound of formula (I) as defined in claim 16 comprising:
(i) reacting a diazo compound of formula (II) 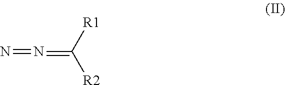
wherein R1 is COOX, wherein X is methyl, ethyl, or tert-butyl, and
R2 is H or methyl;
with an alkene of formula (III) 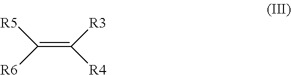
wherein R3 to R6 are defined as shown in compounds (1) to (15), (17) to (31), and (33) to (34) or R3 to R6 are defined as shown in compounds (35) and (36) 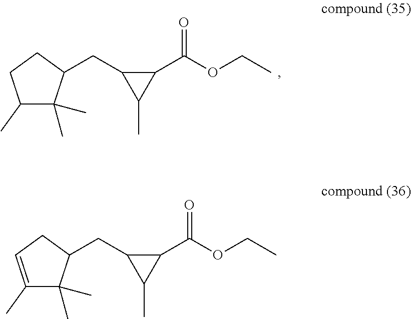
in the presence of a rhodium complex to form a compound selected from compounds (1) to (15), (17) to (31), and (33) to (36), provided that if compound (35) or (36) is formed in (i), the method further comprises:
(ii) reducing compound (35) or (36) to form compound (16) or compound (32).

26. The method of claim 25, wherein the rhodium complex is a rhodium (II) complex with carboxylate ligands.

27. The method of claim 25, wherein compound (35) or (36) are reduced to form compound (16) or compound (32) at a temperature of 10 to 30° C.

28. The method of claim 25, further comprising purifying a reaction product by distillation.

29. The method of claim 25, wherein compound (35) or (36) are reduced to form compound (16) or compound (32) by reaction with LiAlH₄, AlH₃, or Li(Et)₃BH.

30. A compound selected from: 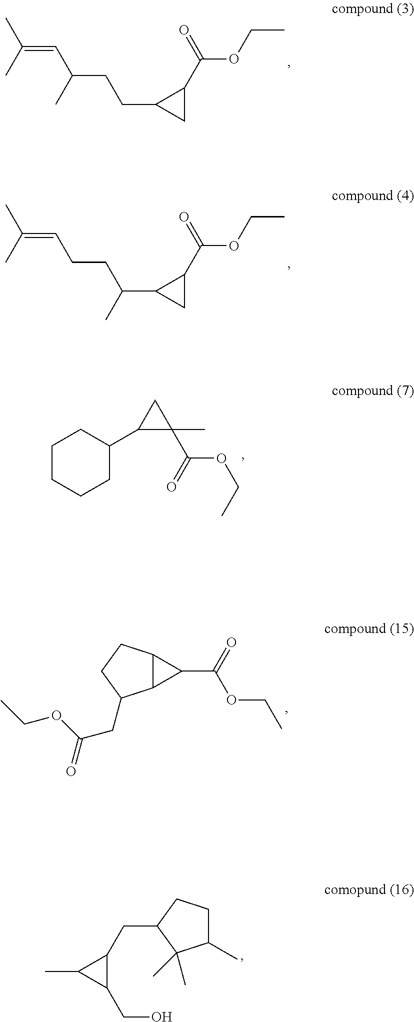 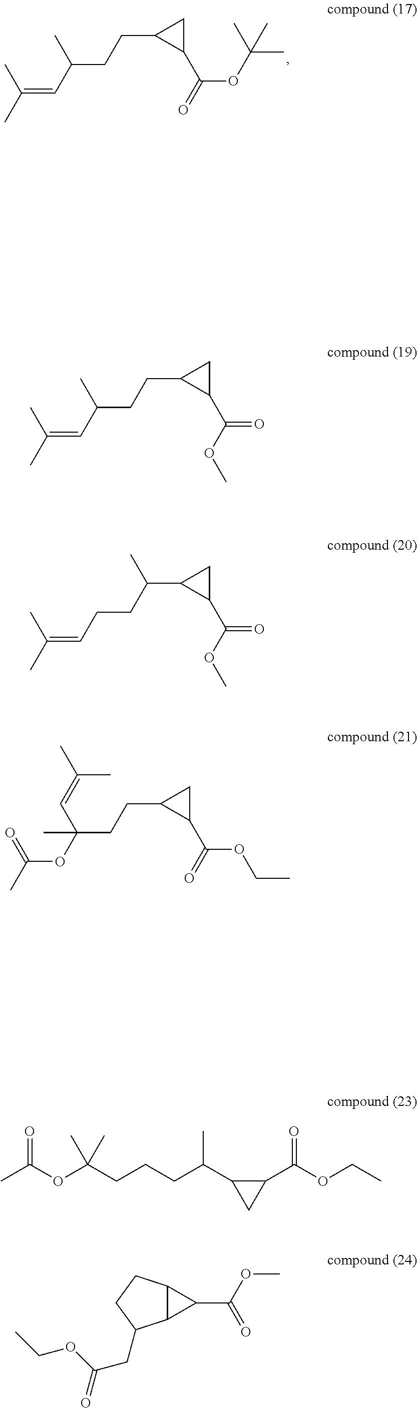 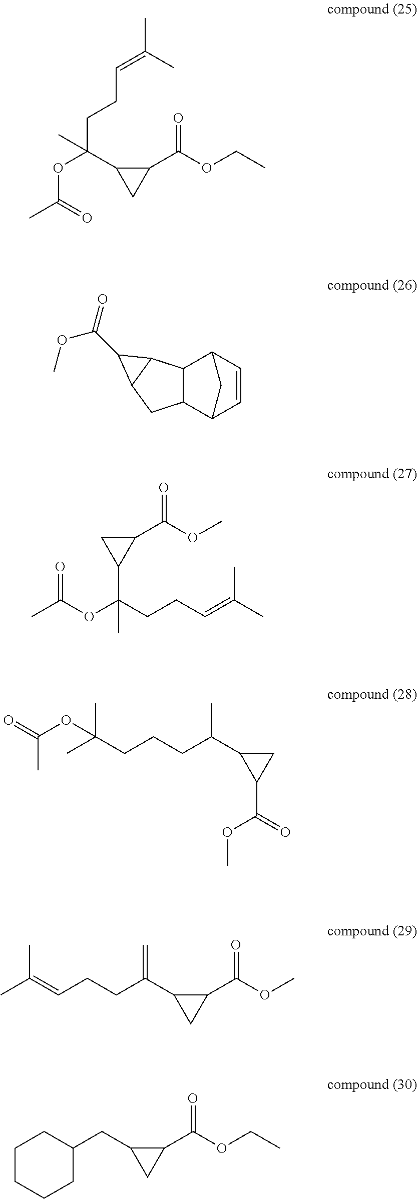 [chemical structure]
